(19) United States
(12) Patent Application Publication
(10) Pub. No.: US 2012/0299930 A1
(43) Pub. Date: Nov. 29, 2012

(54) DATA GENERATING METHOD

(75) Inventor: Junichi GOTO, Matsumoto (JP)

(73) Assignee: SEIKO EPSON CORPORATION, Tokyo (JP)

(21) Appl. No.: 13/476,585

(22) Filed: May 21, 2012

(30) Foreign Application Priority Data
May 23, 2011 (JP) 2011-114415
May 23, 2011 (JP) 2011-114416
May 23, 2011 (JP) 2011-114419

(51) Int. Cl. G06T 11/20; G09G 5/00

(52) U.S. Cl. 345/441; 345/156

(57) ABSTRACT

A data generating method includes: inputting parameter values to an input screen unit having an input box for inputting parameter values that prescribe the image data; and displaying the input parameter values on the auxiliary display screen unit for which the parameter values are displayed as two-dimensional shapes.

### CROSS-REFERENCE TO RELATED APPLICATIONS

This application claims priority to Japanese Patent Application Nos. 2011-114415, 2011-114416 and 2011-114419, all filed on May 23, 2011. The entire disclosures of Japanese Patent Application Nos. 2011-114415, 2011-114416 and 2011-114419 are hereby incorporated herein by reference.

### BACKGROUND

1. Technical Field

The present invention relates to a data generating method for generating drawing data for a large number of media to be drawn on, in order to draw images on the respective media to be drawn on.

2. Related Art

From the past, noting on products of the display of a product name or number or the like, the product lot number or display of an individual identification display or the like has been performed by forming images such as numbers, letters, graphics or the like on the outer surface of industrially manufactured products.

As a drawing method for efficiently forming images on a large number of products, disclosed in Japanese Laid-Open Patent Application Publication No. 2003-80687 is an electronic parts manufacturing method and an electronic parts manufacturing device which implement marking on chip resistors aligned on a tape or substrate using a marking device equipped with an inkjet head, and by rapidly curing the landed ink before it starts to bleed, it is possible to mark small letters and symbols.

However, to generate image data for forming images on a large number of media to be drawn on, it is necessary to handle a large number of parameters such as the size, number, and arrangement of the media to be drawn on, so the work of creating image data was complex.

Japanese Laid-Open Patent Application Publication No. 2002-292483 discloses a laser marking device made to grasp and store printed pattern data corresponding to a printed pattern that is repeatedly printed and a plurality of printed position data corresponding to the position of that printed pattern by using specified reference coordinates and the deviation in relation thereto, and when printing the same characters or the like repeatedly by inputting a correction value from a console and making both reference coordinate correction and deviation correction possible, it becomes possible to easily perform printing position adjustment of the entire character group as well as printing position adjustment of each character.

Japanese Laid-Open Patent Application Publication No. 2009-82963 discloses a laser marking device with a simple operation for inputting marking information which can rapidly execute marking, by creating a calculation formula capable of calculating printing pattern data corresponding to a repeatedly printed printing pattern and coordinate data for the plurality of printing position data corresponding to the position of that printed pattern, and by being able to generate the desired pattern coordinate data based on the calculation results of the calculation formula when input settings are done on the marking information setting screen.

Japanese Laid-Open Patent Application Publication No. 2008-12539 discloses a laser processing device equipped with a process data generating unit, a display unit which is capable of 3D display of an image of the process data, processing failure area detection means for calculating areas for which processing is not possible with the concerned process data, and setting warning means for hiding contents for which processing is not possible, for which at the stage of setting the processing conditions, it is possible to confirm that the processing contents are arranged in an area for which they can be correctly processed, as well as a laser processing condition setting device, a laser processing condition setting method, a laser processing condition setting program, a computer readable storage medium, and an equipment in which it is stored.

### SUMMARY

However, with the devices disclosed in Japanese Laid-Open Patent Application Publication No. 2002-292483 and Japanese Laid-Open Patent Application Publication No. 2009-82963, parameters are only handled as numbers, so there was the problem of potential erroneous setting due to the difficulty of distinguishing each parameter when handling a large number of parameters. Also, even when an erroneous setting has been made, it is difficult to realize that an error was made, so there was the problem that there is a high probability of the image data being output while remaining in that state.

With the device disclosed in Japanese Laid-Open Patent Application Publication No. 2008-12539, it is possible to confirm the set data for an independent image, but it is not possible to handle parameters for aligning a plurality of images, so there was the problem of not being able to eliminate the complexity due to handling a large number of parameters.

The present invention was developed in order to resolve at least some of the above problems and may be worked in the form of the following modes and aspects.

A data generating method according to one aspect of the present invention is a method for generating image data of a drawing image for drawing on a drawing unit to be drawn on equipped with a plurality of media to be drawn on. The data generating method includes: inputting values of parameters for prescribing the image data to an input screen unit having an input box configured and arranged to input the values of the parameters; and displaying the input values of the parameters on an auxiliary display screen unit configured and arranged to display the values of the parameters as two-dimensional shapes.

In accordance with the data generating method described in this aspect, there is a prescribed value input step for inputting parameter values to the input screen unit, and an auxiliary display step for displaying the input parameter values as two-dimensional shapes on the auxiliary display screen unit. By doing this, the operator or the like implementing the parameter value input operation can visually recognize the input parameter values as two-dimensional shapes displayed on the auxiliary display screen unit. By being able to visually recognize the parameter values as two-dimensional shapes, it is possible to easily confirm the parameter values.

With the data generating method of the aforementioned aspect, the parameters preferably include a shape parameter for prescribing a shape of the media and an arrangement parameter for prescribing an arrangement of the media, the auxiliary display screen unit preferably has a preview screen unit configured and arranged to display the two-dimensional shapes representing the shape and an arrangement position of the media, and the displaying of the input values preferably includes displaying the two-dimensional shapes formed according to the value of the shape parameter or the value of the arrangement parameter on the preview screen unit.

With this data generating method, with the auxiliary display step, the shape of the media to be drawn on and the arrangement position corresponding to the input parameter values are displayed as two-dimensional shapes on the preview screen unit. By doing this, the operator or the like implementing the input operation of the parameter values is able to visually recognize the shape and arrangement position of the media to be drawn on as two-dimensional shapes displayed on the preview screen unit. Being able to visually recognize the shape and arrangement position of the media to be drawn on as two-dimensional shapes makes it possible to easily confirm the shape and arrangement position of the media to be drawn on.

With the data generating method of the aforementioned aspect, the input screen unit preferably includes a substrate thickness input screen unit configured and arranged to input a thickness of a substrate of the drawing unit supporting the media.

With this data generating method, at the prescribed value input step, it is possible to use the screen of the substrate thickness input screen unit to input the thickness of the drawing unit substrate. This makes it possible to add the thickness information of the drawing unit substrate to the formed image data.

With the data generating method of the aforementioned aspect, the auxiliary display screen unit preferably has a parameter position display screen unit configured and arranged to indicate a part to which the parameters correspond in the two-dimensional shapes showing a shape and an arrangement position of the media.

With this data generating method, on the parameter position display screen unit of the auxiliary display screen unit is displayed the part to which the parameter corresponds with the two-dimensional shapes showing the shape and arrangement position of the media to be drawn on. This makes it possible to visually recognize the parameters as two-dimensional shapes displayed on the auxiliary display screen unit. Being able to visually recognize the parameters as two-dimensional shapes makes it possible to more easily recognize the parameters.

With the data generating method of the aforementioned aspect, at least one of the input box configured and arranged to input the values of the parameters corresponding to the selected position and a display of the input box is preferably highlighted in correspondence to a selection of a specified position on the parameter position display screen unit.

With this data generating method, the input box for inputting the parameter value corresponding to the selected position or the input box display is shown with highlighted display on the parameter position display screen unit. This makes it possible to select the parameter for which the value is input using the screen displayed on the parameter position display screen unit, and to easily recognize the input box corresponding to the selected parameter and the input box display.

The data generating method of the aforementioned aspect preferably further includes sending warning information when there is a mismatch in acquired values of the parameters.

With this data generating method, when the acquired parameter value is an unsuitable value, warning information is sent at the mismatch warning step. By sending warning information, it is possible to notify the operator who is inputting parameter values for acquiring parameter values to the data generating device that the acquired parameter value is unsuitable. This makes it possible to inhibit the generation of image data using unsuitable parameter values.

A data generating method according to another aspect of the present invention is a method for generating image data of a drawing image for drawing a media image on a plurality of media to be drawn on equipped to a drawing unit to be drawn on. The data generating method includes: acquiring a value of a parameter for prescribing a shape of the media; acquiring a value of a parameter for prescribing a position of the media with respect to the drawing unit to be drawn on; and prescribing a position of the media image on the drawing image based on the values of the parameters acquired.

With the data generating method of these aspects, the position of the media image on the drawing image is prescribed by the parameter values prescribing the shape of the media to be drawn on and the parameter values prescribing the position of the media to be drawn on. It is possible to prescribe the shape of the unit to be drawn on by the parameter values prescribing the shape of the concerned media to be drawn on and the parameter values prescribing the position of the media to be drawn on. The unit to be drawn on is the object of drawing of the drawing image, and exists as a tangible object. That makes it possible for the operator or the like implementing the input operation of the parameter values for acquiring the parameter values to associate the input parameter values with a unit to be drawn on, making it easier to recognize as a specific shape. Being able to recognize the parameter value as a specific shape makes it possible to easily confirm the parameter value.

### BRIEF DESCRIPTION OF THE DRAWINGS

Referring now to the attached drawings which form a part of this original disclosure:

FIG. 1A is a descriptive diagram showing a semiconductor package on which a marking image is drawn, FIG. 1B is a descriptive diagram showing a package drawing unit for which semiconductor packages are aligned on a holding substrate, FIG. 1C is a descriptive diagram showing a marking image drawn on a semiconductor chip, FIG. 1D is a descriptive diagram showing the state with semiconductor chips aligned on the holding substrate.

FIG. 2 is a descriptive diagram showing the configuration of the drawing device unit.

FIG. 3A is an external perspective view showing the schematic configuration of the overall droplet discharge device, and FIG. 3B is an external perspective view showing the schematic configuration of the droplet discharge head that the droplet discharge device is equipped with.

FIG. 4 is a descriptive diagram showing the functional configuration of the image data generating device.

FIG. 5 is a flow chart showing the steps for generating drawing image data.

FIG. 6A is a descriptive diagram schematically showing the setting screen, and FIG. 6B is a descriptive drawing showing an example of a setting screen for which only a portion of the parameters are displayed on the parameter display unit.

FIG. 7A is a descriptive diagram showing an example of the setting screen in a state when the input box is selected. FIG. 7B is a descriptive diagram showing an example of the setting screen in a state when the parameter input is completed.

FIG. 8A is a descriptive diagram showing an example of the setting screen display when a warning screen is displayed, and FIG. 8B is a descriptive diagram showing an example of the setting screen display when the warning screen has been deleted.

FIG. 9A is a descriptive diagram showing the setting screen for implementing option settings for the drawing unit, and FIG. 9B is a descriptive diagram showing the setting screen for implementing option settings for the chip unit.

FIG. 10A is a descriptive diagram showing an example of the setting screen display on which the warning screen is displayed, and FIG. 10B is a descriptive diagram showing an example of the setting screen when the warning screen has been deleted.

FIG. 11A is a descriptive diagram showing the setting screen for implementing the alignment mark position setting, and FIG. 11B is a descriptive diagram showing the setting screen for implementing the position setting of the front/back distinguishing mark.

FIG. 12A is a descriptive diagram showing an example of the setting screen display when the warning screen is displayed, and FIG. 12B is a descriptive diagram showing an example of the setting screen display when the warning screen is deleted.

FIG. 13A is a descriptive diagram showing an example of the setting screen display when the warning screen is displayed, and FIG. 13B is a descriptive diagram showing the setting screen when the drawing mode is set for the droplet discharge device.

FIG. 14A is a descriptive diagram showing the setting screen when setting the parameter values relating to margins, and FIG. 14B is a descriptive diagram showing the setting screen for implementing the preprocessing setting process.

FIG. 15A is a descriptive diagram showing the image pasting screen before pasting the image of the chip image, and FIG. 15B is a descriptive diagram showing image pasting screen after pasting the image of the chip image.

FIG. 16 is a descriptive diagram showing an example of the generated drawing image data.

### DETAILED DESCRIPTION OF EXEMPLARY EMBODIMENTS

Following, we will describe the data generating method while referring to the drawings. With this embodiment, we will describe an example of a data generating method used for generating image data of a drawing image for forming a marking image on an object to be marked (hereafter noted as drawing image data). With this embodiment, a drawing image prescribed by drawing image data is drawn using a droplet discharge device equipped with an inkjet type droplet discharge head. Note that in the drawings referred to with the description hereafter, for convenience of illustration, there are cases when the vertical and horizontal scale of the members or parts differ from the actual item. The object to be marked correlates to the media to be drawn on.

### Object to be Marked

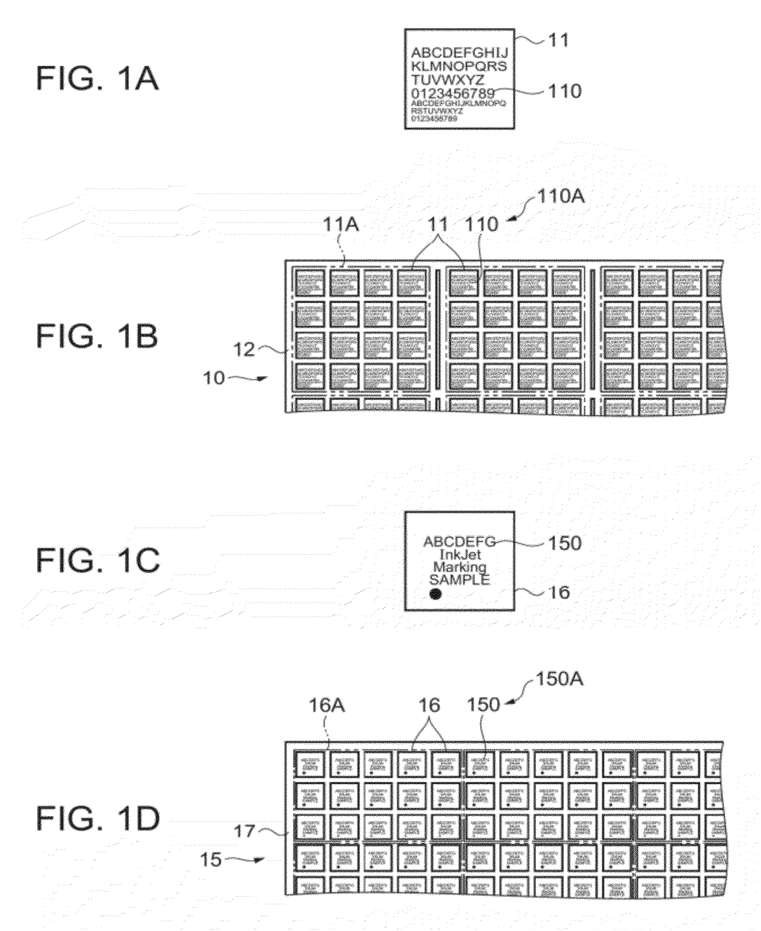

First, we will describe the object to be marked while referring to FIG. 1. FIG. 1 is a descriptive diagram showing an object to be marked, and the marking image drawn on the object to be marked. FIG. 1A is a descriptive diagram showing a semiconductor package on which a marking image is drawn. FIG. 1B is a descriptive diagram showing a package drawing unit for which semiconductor packages are aligned on a holding substrate. FIG. 1C is a descriptive diagram showing a marking image drawn on a semiconductor chip. FIG. 1D is a descriptive diagram showing the state with semiconductor chips aligned on the holding substrate.

The semiconductor package 11 shown in FIG. 1A is a package mounted with a flip chip connection. A package image 110 which is a marking image is drawn on the surface on the opposite side of the surface on which bumps are formed. The package image 110 is an image such as a logo mark, product name, product number, lot number or the like.

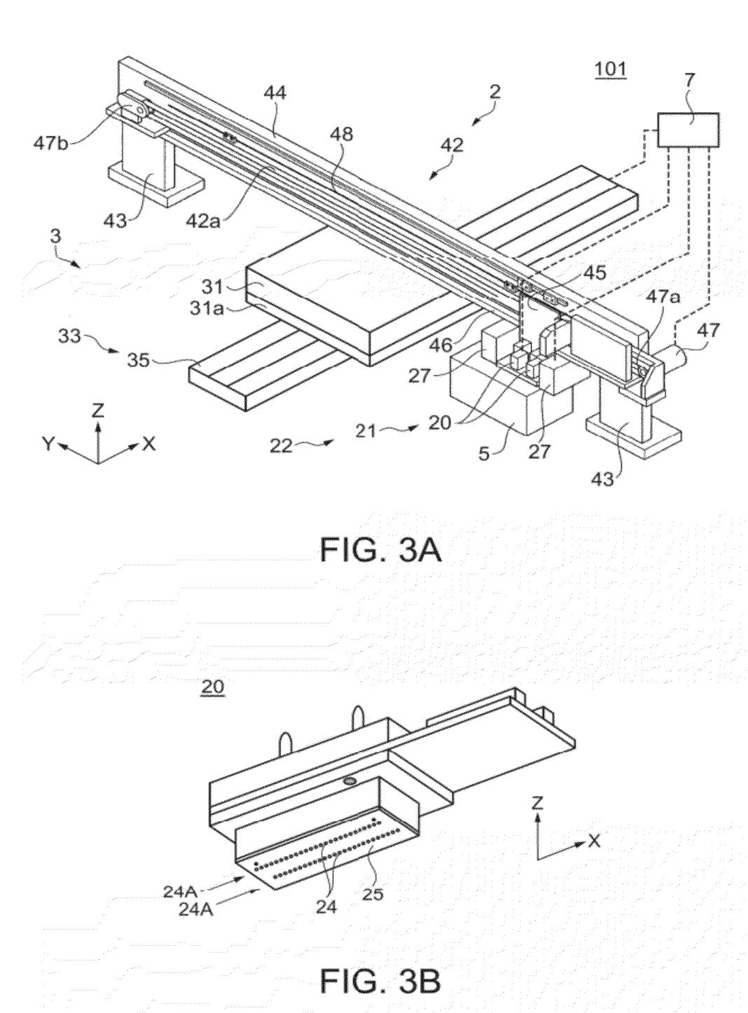

As shown in FIG. 1B, the package drawing unit 10 is constituted by aligning and temporarily fixing semiconductor packages 11 on the holding substrate 12. The image drawn on the package drawing unit 10 is noted as the package drawing image 110A. By placing the package drawing unit 10 on the media placement platform 31 (see FIG. 3 of the droplet discharge device 101 (see FIG. 3) and drawing the package drawing image 110A on the package drawing unit 10, the package image 110 is drawn on the semiconductor package 11. A set of 16 semiconductor packages 11 aligned in 4 rows by 4 columns is noted as a package unit 11A.

The semiconductor package 11 correlates to the media to be drawn on. The package drawing unit 10 correlates to the unit to be drawn on. The package image 110 correlates to the media image. The package drawing image 110A correlates to the drawing image.

With the semiconductor chip 16 shown in FIG. 1C, the chip image 150 which is the marking image is drawn on the surface on the opposite side to the surface on which the bonding pad is formed. The chip image 150 is an image such as a logo mark, product name, product number, lot number or the like, for example.

As shown in FIG. 1D, the chip drawing unit 15 is constituted by aligning and temporarily fixing semiconductor chips 16 on the holding substrate 17. The image drawn on the chip drawing unit 15 is noted as the chip drawing image 150A. The chip image 150 is drawn on the semiconductor chip 16 by placing the chip drawing unit 15 on the media placement platform 31 of the droplet discharge device 101, and drawing the chip drawing image 150A on the chip drawing unit 15. A set of 15 semiconductor chips 16 aligned in 3 rows by 5 columns is noted as the chip unit 16A.

The semiconductor chip 16 correlates to the media to be drawn on. The chip drawing unit 15 correlates to the unit to be drawn on. The chip image 150 correlates to the media image. The chip drawing image 150A correlates to the drawing image.

### Drawing Device Unit

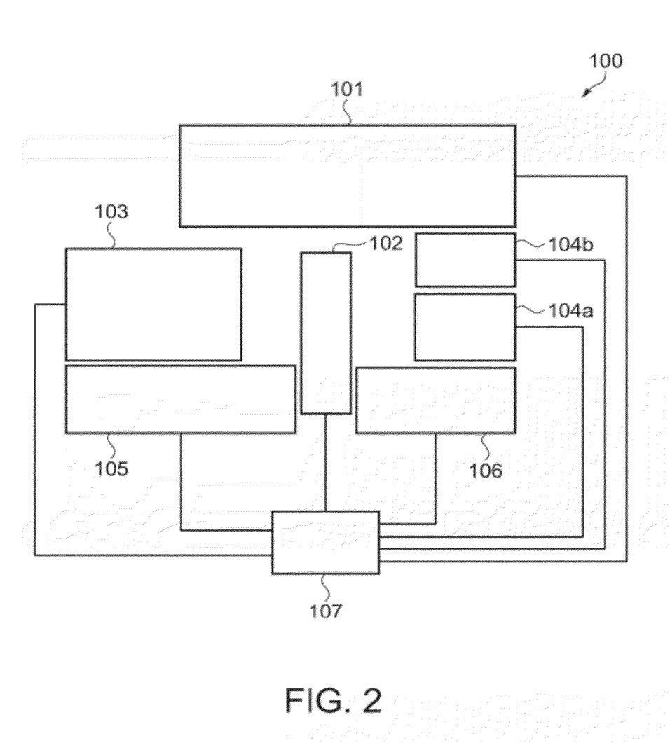

Next, we will describe the drawing device unit for drawing images such as the chip drawing image 150A on a drawing object such as the chip drawing unit 15 described above while referring to FIG. 2. FIG. 2 is a descriptive diagram showing the configuration of the drawing device unit.

As shown in FIG. 2, the drawing device unit 100 is equipped with a droplet discharge device 101, a transfer robot 102, a preprocessing device 103, a temperature regulating device 104a, a temperature regulating device 104b, a loading device 105, an unloading device 106, and a drawing unit control device 107.

The chip drawing unit 15 or the like is mounted in a specified magazine. By loading a magazine in which the chip drawing unit 15 or the like is mounted in the loading device 105, the chip drawing unit 15 or the like is supplied to the drawing device unit 100.

The chip drawing unit 15 or the like for which processing in the drawing device unit 100 has ended is mounted on the magazine loaded in the unloading device 105. By removing the concerned magazine from the unloading device 106, the already processed chip drawing unit 15 or the like is removed from the drawing device unit 100.

The transfer robot 102 takes out the chip drawing unit 15 or the like from the magazine loaded in the loading device 105 and places it at a specified position such as the droplet discharge device 101 or the like. Also, the chip drawing units 15 or the like processed by the droplet discharge device 101 or the like are removed from the droplet discharge device 101 or the like and supplied to the device for implementing the next process.

The droplet discharge device 101 draws an image such as the chip drawing image 150A on a drawing object such as the chip drawing unit 15.

The preprocessing device 103 implements preprocessing to make the chip drawing unit 15 or the like in an optimal state for being drawn on by the droplet discharge device 101.

The temperature regulating device 104a and temperature regulating device 104b adjust the temperature of the chip drawing unit 15 or the like to an optimal temperature for implementing processing by the preprocessing device 103 or drawing by the droplet discharge device 101. These are also sometimes used for implementing heating or the like to cure the functional fluid that constitutes the chip drawing image 150A or the like.

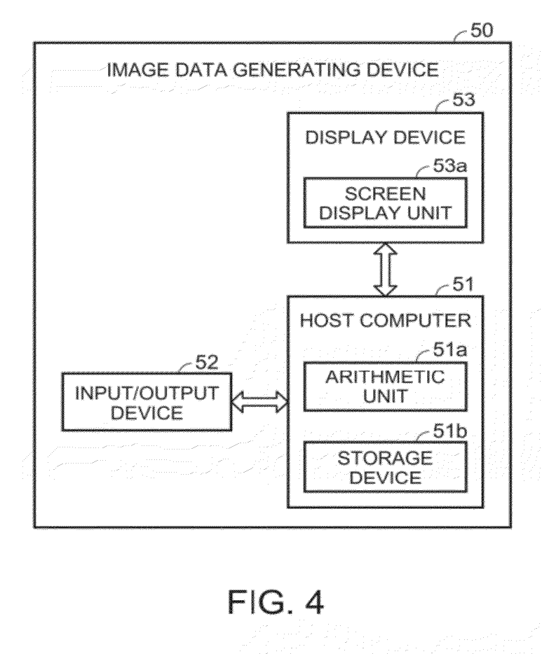

The drawing unit control device 107 controls each device or the like noted above according to the image data generated using the image data generating device 50 (see FIG. 4), and has an image such as the chip drawing image 150A drawn on a drawing object such as the chip drawing unit 15.

### Droplet Discharge Device

Next, we will describe the droplet discharge device 101 while referring to FIG. 3. FIG. 3 is an external perspective view showing the schematic configuration of the droplet discharge device. FIG. 3A is an external perspective view showing the schematic configuration of the overall droplet discharge device, and FIG. 3B is an external perspective view showing the schematic configuration of the droplet discharge head that the droplet discharge device is equipped with.

As shown in FIG. 3A, the droplet discharge device 101 is equipped with a head mechanical unit 2, a media mechanical unit 3, a maintenance device unit 5, and a discharge device control unit 7. The head mechanical unit 2 has a droplet discharge head 20 for discharging the functional fluid as droplets. The droplet discharge device 101 is also equipped with a functional fluid supply unit or a discharge test device unit which are not illustrated. The functional fluid discharged from the droplet discharge head 20 is supplied from the functional fluid supply unit to the droplet discharge head 20. The discharge device control unit 7 comprehensively controls each of the functional units and the like noted above.

The head mechanical unit 2 is equipped with a carriage unit 22 and a carriage scanning mechanism 42. The carriage unit 22 is equipped with a head unit 21 which has the droplet discharge head 20, and an ultraviolet radiation unit 27 for radiating ultraviolet rays. The carriage scanning mechanism 42 is equipped with a carriage frame 45 on which the carriage unit 22 is suspended, and by moving the carriage frame 45 in the Y axis direction, the carriage unit 22 is moved in the Y axis direction.

The carriage scanning mechanism 42 is equipped with a support column 43, a support beam 44, a guide unit 46, a drive motor 47, a drive pulley 47a, a driven pulley 47b, a belt 42a, a carriage frame 45, and an encoder 48.

The support beam 44 is provided so as to be placed across two support columns 43, and extends in the Y direction. The drive pulley 47a is fixed on the output shaft of the drive motor 47, and the drive pulley 47a is rotationally driven by the drive motor 47. The driven pulley 47b is fixed to be able to rotate on the support beam 44 near the end of the side opposite the side on which the drive motor 47 is fixed in the Y direction of the support beam 44. The shaft direction of the rotation shaft of the driven pulley 47b is roughly parallel to the shaft direction of the rotation shaft of the drive pulley 47a (output shaft of the drive motor 47). The belt 42a is placed spanning between the drive pulley 47a and the driven pulley 47b, and is driven by the drive pulley 47a rotating. The belt 42a extends in the Y axis direction in parallel with the guide unit 46. The encoder 48 is fixed to the support beam 44, and extends in the Y axis direction roughly parallel to the guide unit 46.

The carriage frame 45 is fixed on the belt 42a. The carriage frame 45 is engaged to be able to freely slide in the Y axis direction on the guide unit 46. The carriage frame 45 is driven in the Y axis direction along the guide unit 46 by the belt 42a being driven by the drive motor 47. The Y axis direction position of the carriage frame 45 is detected by the encoder 48.

The carriage frame 45, by being moved in the Y axis direction by the carriage scanning mechanism 42, can freely move the droplet discharge head 20 which has the head unit 21 provided across the carriage frame 45 in the Y axis direction. It is also possible to hold it in any of the moved positions.

As shown in FIG. 3B, the droplet discharge head 20 is equipped with a nozzle substrate 25. Two rows of nozzle rows 24A for which a large number of discharge nozzles 24 are aligned roughly in a straight line are formed on the nozzle substrate 25. The functional fluid is discharged as droplets from the discharge nozzles 24, and by landing on the chip drawing unit 15 or the like at a position facing opposite, the functional fluid is arranged at the concerned position. The nozzle row 24A extends in the X axis direction shown in FIG. 3A in a state with the droplet discharge head 20 mounted on the droplet discharge device 101. The discharge nozzles 24 are aligned at a nozzle pitch at uniform intervals in the nozzle row 24A, and the position of the discharge nozzles 24 is displaced by a half nozzle pitch in the X axis direction between the two rows of nozzle rows 24A. By doing this, the droplet discharge head 20 is able to arrange droplets of the functional fluid at half nozzle pitch intervals in the X axis direction.

As shown in FIG. 3A, the media mechanical unit 3 is equipped with a media placement platform 31, a slide platform 31a, and a media moving mechanism 33.

The media moving mechanism 33 is equipped with an X axis guide 35 and an X axis linear motor (not illustrated). The X axis guide 35 is arranged under the support beam 44 between the two support columns 43, and extends roughly parallel in the X axis direction orthogonal to the Y axis direction.

The slide platform 31a is supported on the X axis guide 35 so as to be able to slide freely in the X axis direction. The X axis linear motor is arranged roughly parallel to the X axis guide 35, and the slide platform 31a is moved in the X axis direction by the X axis linear motor. This can also be held at any moved position. The media placement platform 31 is fixed and supported on the slide platform 31a so as to be able to rotate in the direction around the axis parallel to the Z axis direction which is orthogonal to the X axis direction and the Y axis direction.

By moving the slide platform 31a in the X axis direction using the media moving mechanism 33, it is possible to freely move the media placement platform 31 which is fixed and supported on the slide platform 31a in the X axis direction. It is also possible to hold this at any moved position. Specifically, it is possible to freely move a chip drawing unit 15 or the like which is held on the media placement platform 31 in the X axis direction. It is also possible to hold this at any moved position.

The droplet discharge head 20 which has the head unit 21 placed across the carriage frame 45 is held on the head mechanical unit 2 with the nozzle substrate 25 facing downward. The chip drawing unit 15 or the like held on the media placement platform 31 is moved to the position at which the droplet discharge head 20 can face opposite in the X axis direction and stopped, is synchronized to the Y axis direction movement of the droplet discharge head 20 (head unit 21) that is above, and discharges the functional fluid as droplets. By controlling the chip drawing unit 15 or the like that moves in the X axis direction and the droplet discharge head 20 that moves in the Y axis direction relative to each other, by landing droplets at any desired position on the chip drawing unit 15 or the like, it is possible to implement the desired planar shape drawing.

One each of the ultraviolet radiation units 27 for curing the ultraviolet ray curing type functional fluid is provided on both sides in the Y axis direction of the head unit 21 on the carriage unit 22. The images drawn using the ultraviolet ray curing type functional fluid can be cured using the ultraviolet ray radiation unit 27.

The discharge device control unit 7 is electrically connected with the droplet discharge head 20, the ultraviolet ray radiation unit 27, the drive motor 47 of the carriage scanning mechanism 42, the X axis linear motor of the media movement mechanism 33 and the like. Control signals are sent from the control unit that the discharge device control unit 7 is equipped with, and the droplet discharge head 20, the ultraviolet ray radiation unit 27, the drive motor 47, the X axis linear motor or the like is operated.

The maintenance device unit 5 is equipped with various type of maintenance devices. Maintenance devices are devices that implement various types of maintenance of the droplet discharge head 20. When implementing maintenance of the droplet discharge head 20, the head unit 21 (droplet discharge head 20) is moved to a position facing the maintenance device unit 5 using the carriage scanning mechanism 42, and maintenance work is implemented.

### Image Data Generating Device

Next, while referring to FIG. 4, we will describe the image data generating device 50 used for generating drawing image data for drawing chip drawing images 150A or the like using the drawing device unit 100. FIG. 4 is a descriptive diagram showing the functional configuration of the image data generating device.

As shown in FIG. 4, the image data generating device 50 is equipped with a host computer 51, a display device 53, and an input/output device 52.

The host computer 51 is equipped with an arithmetic unit 51a and a storage device 51b. The storage device 51b stores programs, data and the like for having the image data generating device 50 function as a device for generating drawing image data. The arithmetic unit 51a performs calculations for generating drawing image data according to the program stored in the storage device 51b.

The display device 53 is equipped with a screen display unit 53a. The display device 53 is controlled by the host computer 51, and displays on the screen display unit 53a various types of setting screens used for generating drawing image data.

The input/output device 52 functions as an input means for inputting numerical values or the like for parameters that prescribe programs or data stored in the storage device 51b or drawing image data. It also functions as an output means for the generated drawing image data.

### Drawing Image Data Generating Step and Setting Screen

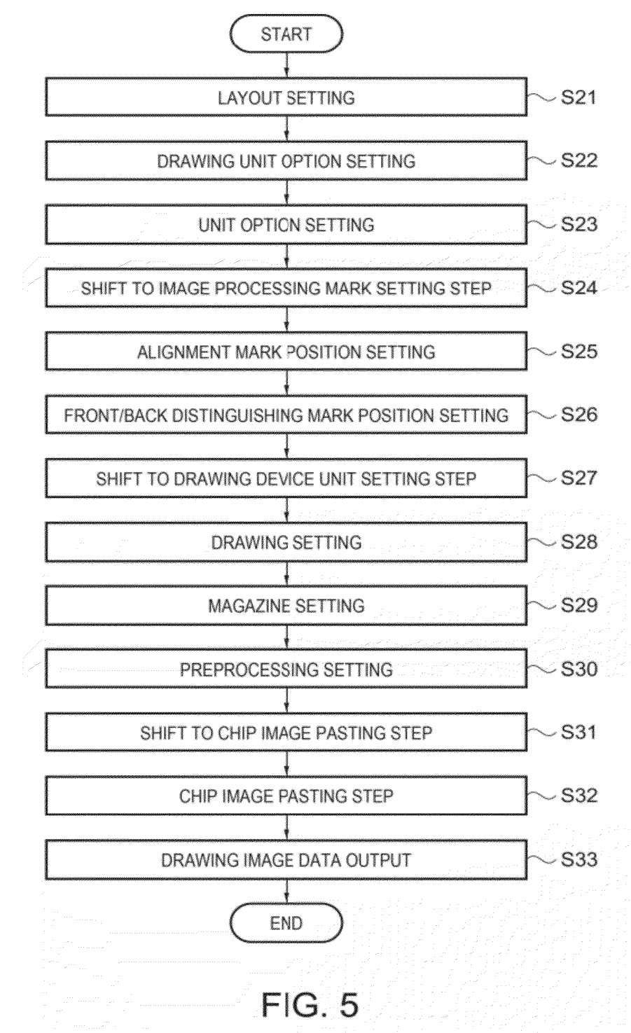

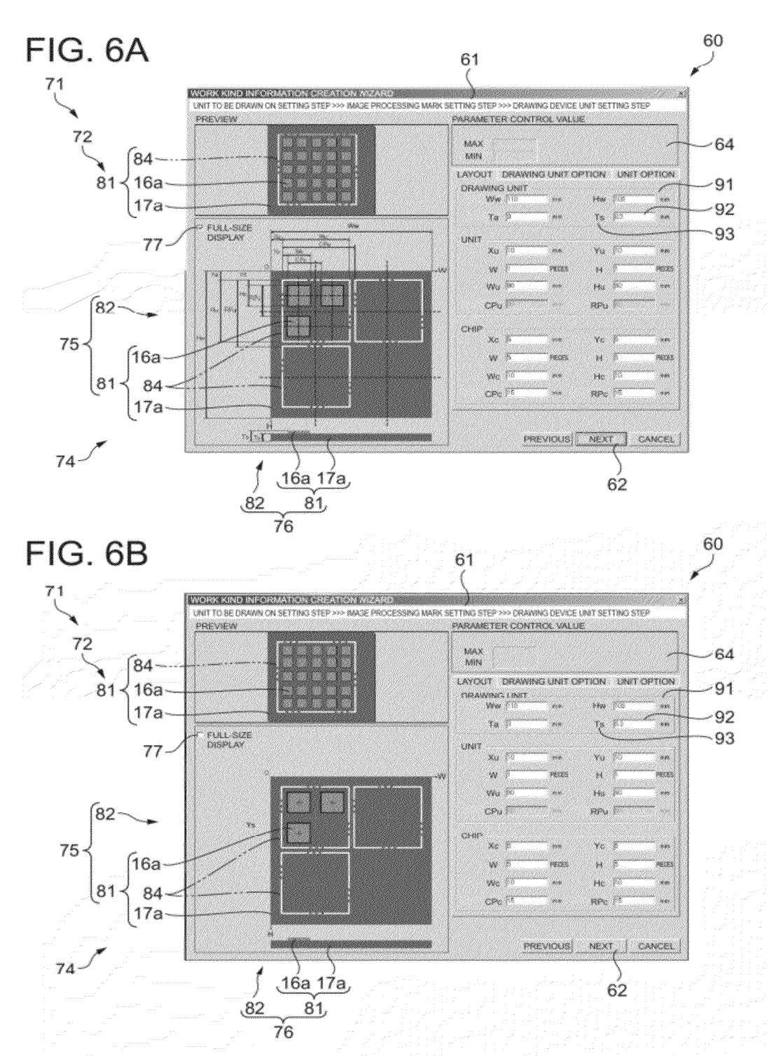

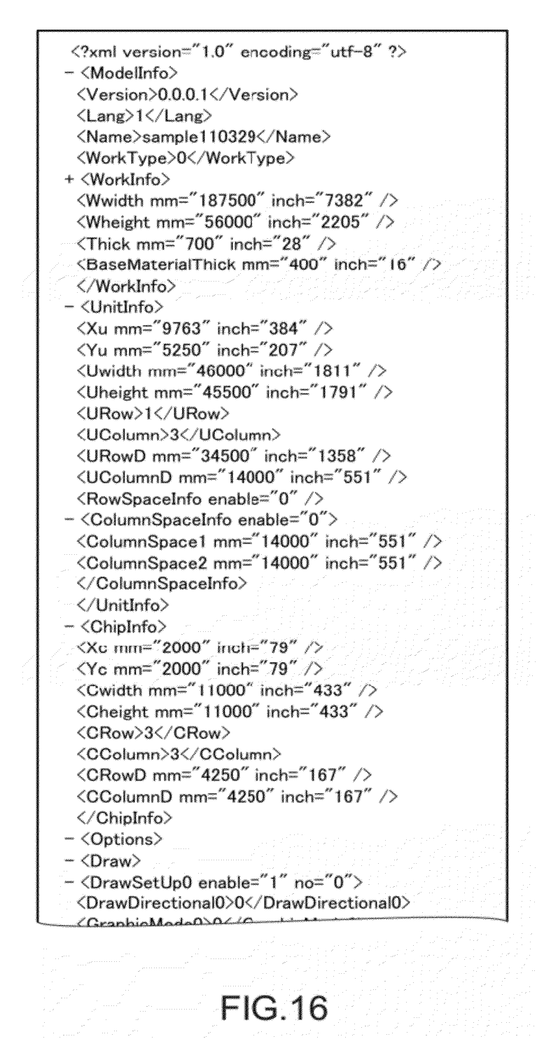

Next, while referring to FIGS. 5 through 16, we will describe the steps for generating the drawing image data using the image data generating device 50 using as an example the steps for generating the drawing image data of the chip drawing image 150A for drawing the chip drawing unit 15 described above. FIG. 5 is a flow chart showing the steps for generating the drawing image data. FIG. 6 to FIG. 15 are descriptive diagrams showing the setting screens displayed with the steps of generating the drawing image data. FIG. 16 is a descriptive drawing showing an example of the generated drawing image data.

### Setting Screens

With the image data generating device 50, various types of setting screens used for generating drawing image data are displayed on the screen display unit 53a. The operator generating the drawing image data using the image data generating device 50 inputs data for generating the drawing image data according to the displayed setting screen. FIG. 6A is a descriptive diagram schematically showing the setting screen.

The setting screen 60 shown in FIG. 6A is the initial setting screen 60. When newly generating drawing image data, by selecting Create New drawing image data, the initial setting screen 60 shown in FIG. 6A is displayed on the screen display unit 53a. As shown in FIG. 6A, the setting screen 60 is equipped with a process display screen 61, an auxiliary display screen 71, an input screen 91, a step shift button 62, and a limit value display screen 64.

The process display screen 61 displays three steps for inputting data relating to the chip drawing unit 15, and the step currently being implemented among the three steps. The three steps for inputting data relating to the chip drawing unit 15 are the step of setting the unit to be drawn on, the step of setting the image processing mark, and the step of setting the drawing device unit. The text indicating the step of setting the unit to be drawn on shows that the step currently being implemented is the step of setting the unit to be drawn on rather than the text indicating the step of setting the image processing mark or the step of setting the drawing device unit. The text indicating the step currently being implemented is differentiated from the text showing the other steps and made easy to see by making it bold or making the color darker, for example.

The step shift button 62 is a button for changing the implemented step. It is possible to change the setting screen 60 of the step for setting the unit to be drawn on to the setting screen 60 of the step for setting the image processing by clicking the step shift button 62, for example, and to change the step to be implemented.

The input screen 91 is a screen for inputting parameter values for prescribing the chip drawing unit 15. The input screen 91 has input boxes 92 and box displays 93. By selecting an input box 92 and inputting numerical values, it is possible to input the parameter values for which the selected input box 92 was allocated. The box display 93 displays parameters for which the input box 92 was allocated. 20 input boxes 92 are set in the input screen 91 shown in FIG. 6A, so it is possible to set numerical values for 20 parameters. Selection of the input box 92 is implemented by clicking the input box 92 to be selected or the box display 93 corresponding to the concerned input box 92. The part displayed by the input screen 91 in the screen display unit 93 correlates to the input screen unit. The box display 93 correlates to the input box display.

The auxiliary display screen 71 is equipped with a preview screen 72 and a parameter position screen 74. The auxiliary display screen 71 is a screen that displays the parameters input from the input screen 91 in a two-dimensional shape such as a drawing. The part displayed by the auxiliary display screen 71 on the screen display unit 53a correlates to the auxiliary display screen unit.

The parameter position screen 74 is equipped with a flat display screen 75, a thickness display screen 76, and a display selection box 77.

The flat display screen 75 and the thickness display screen 76 are equipped with a graphic display unit 81 and a parameter display unit 82. The graphic display unit 81 of the flat display screen 75 has a chip display image 16a, a holding substrate display image 17a, and a unit frame 84. The graphic display unit 81 of the thickness display screen 76 has a chip display image 16a and a holding substrate display image 17a. The chip display image 16a and the holding substrate display image 17a show an overview of the outline of the semiconductor chip 16 or the holding substrate 17 in a roughly rectangular shape. The unit frame 84 shown as a double dot-dash line roughly rectangular shape in FIG. 6 indicates the chip unit 16A of the semiconductor chip 16. The plurality of semiconductor chips 16 surrounded by the unit frame 84 are handled as one chip unit 16A. With the flat display screen 75 and the thickness display screen 76, the schematic shape of the chip drawing unit 15 is shown by the chip display image 16a, the holding substrate display image 17a, and the unit frame 84. With the flat display screen 75, the planar shape of the chip drawing unit 15 is shown in schematic form. With the thickness display screen 76, the side surface shape of the chip drawing unit 15 is shown in schematic form.

The parameter display unit 82 shows the part corresponding to each parameter in the graphic display unit 81. With the parameter display unit 82, the parts corresponding to each parameter are shown in the graphic display unit 81 such as with dimension lines and dimension auxiliary lines. For example, from both ends respectively of one side of the chip display image 16a, the width We of the semiconductor chip 16 is shown by the lines in the dimension auxiliary line form drawn roughly perpendicularly to the concerned one side, and the line of the dimension line form drawn roughly parallel to the corresponding one side between the lines of the concerned dimension line form.

The input box 92 for inputting values of the concerned parameters corresponding to the parameters displayed on the parameter display unit 82 is formed on the input screen 91. With the input screen 91, the name of the parameter displayed on the parameter display unit 82 is displayed as the box display 93 of the input box 92 corresponding to the concerned parameter. It is also possible to select the parameter corresponding to the concerned display (input box 92) by clicking the display of the parameter display unit 82. The part displayed by the parameter position screen 74 in the screen display unit 53a correlates to the parameter position display screen unit.

The display selection box 77 is a check box. As with the display selection box 77 shown in FIG. 6A, when the display selection box 77 is checked, as with the parameter display unit 82 shown in FIG. 6A, all the parameters are displayed in the parameter display unit 82. FIG. 6B is a descriptive diagram showing an example of a setting screen for which only a part of the parameters are displayed on the parameter display unit. As with the display selection box 77 shown in FIG. 6B, when a check is not placed in the display selection box 77, only the parameters corresponding to the input box 82 selected with the input screen 91 are displayed on the parameter display unit 82. With the input screen 91 shown in FIG. 6B, since the input box 92 is not selected, the parameter display unit 82 is not displayed in the flat display screen 75 and the thickness display screen 76 shown in FIG. 6B.

The preview screen 72 has the chip display image 16a, the holding substrate display image 17a, and the unit frame 84. The same as with the graphic display unit 81 described above, the chip display image 16a and the holding substrate display image 17a show an overview of the outline of the semiconductor chip 16 or the holding substrate 17 in a roughly rectangular shape. The unit frame 84 shows the range of the chip unit 16A of the semiconductor chip 16. With the preview screen 72, the shape of the chip display image 16a, the holding substrate display image 17a, and the unit frame 84 are in a shape corresponding to the parameter values input to the input screen 91. For example, the vertical to horizontal ratio of the chip display image 16a, the holding substrate display image 17a, and the unit frame 84 is the same ratio as that of the input vertical direction dimension and the horizontal width. The size ratio of the chip display image 16a, the holding substrate display image 17a, and the unit frame 84 is the same ratio as that of the input semiconductor chip 16 dimension value, the holding substrate 17 dimension value, and the chip unit 16A range size dimension value. Therefore, the image of the chip drawing unit 15 displayed on the preview screen 72 is a reduced view or enlarged view of the chip drawing unit 16 of the shape corresponding to the input parameter values. The part displayed by the preview screen 72 on the screen display part 53a correlates to the preview screen unit.

The maximum value and minimum value that can be set as parameter values are displayed on the limit value display screen 64. The concerned maximum value and minimum value are the maximum value and minimum value for the parameters corresponding to the input box 92 selected with the input screen 91. For the maximum value and minimum value, for example, values that can be physically set are set in advance for each parameter. A value which cannot be physically set is for example a parameter that is the width of the holding substrate 17 of the chip drawing unit 15, for which the value of the width of the holding substrate 17 is greater than the width can be placed on the droplet discharge device 101. A value that cannot be physically set is for example a parameter that is the width of the semiconductor chip 16, for which the width of the semiconductor chip 16 is smaller than the minimum pitch that can be drawn by the droplet discharge device 101.

### Drawing Image Data Generating Step

To generate drawing image data, first, the host computer 51 of the image data generating device 50 is activated, and for example Create New is selected. By selecting Create New, the setting screen 60 described while referring to FIG. 6A is displayed on the screen display unit 53a.

With the description hereafter, the horizontal direction on the setting screen 60 is noted as the W axis direction, and the vertical direction that is perpendicular to the W axis direction is noted as the H axis direction. With the auxiliary display screen 71 shown in FIG. 6A or the like, the sides of the chip display image 16a and the holding substrate display image 17a are roughly parallel to the W axis direction or the H axis direction. The chip display image 16a is aligned in a state constituting rows roughly parallel to the W axis direction and columns roughly parallel to the H axis direction. The directions correlating to the W axis direction or the H axis direction for the chip display image 16a or the holding substrate display image 17a are also noted as the W axis direction or the H axis direction with the semiconductor chip 16 or the holding substrate 17 as well.

First, by implementing from step S21 to step S23 of FIG. 5, the step of setting the unit to be drawn on is implemented, and data relating to the chip drawing unit 15 is input.

At step S21 of FIG. 5, layout setting of the chip drawing unit 15 is implemented. Layout setting is implemented by inputting the setting value to the input box 92 of the input screen 91. By selecting Create New, default values are displayed in the input box 92 of the displayed setting screen 60.

With the input screen 91, 20 input boxes 92 are arranged in 10 rows and 2 columns.

The input boxes 92 of the second row from the top are items for inputting parameters relating to the overall chip drawing unit 15. The parameter input from the input box 92 of the first column of the first row is the W axis direction of the holding substrate 17. The parameter input from the input box 92 of the first row and second column is the width of the H axis direction of the holding substrate 17. The parameter input from the input box 82 of the second row and first column is the thickness of the chip drawing unit 15, and is the thickness for which the thickness of the semiconductor chip 16 is added to the thickness of the holding substrate 17. The parameter input from the input box 82 of the second row and the second column is the thickness of the holding substrate 17.

The part displayed by the input box 92 for inputting the thickness of the holding substrate 17 in the screen display unit 53a correlates to the substrate thickness input screen unit.

The input boxes 92 from the third row from the top to the sixth row are for inputting the parameters relating to the configuration of the chip unit 16A on the chip drawing unit 15.

The parameters input from the input boxes 92 of the third row are coordinates of the reference point position of the chip unit 16A (unit frame 84). The chip unit reference point is one corner of the unit frame 84 (upper left corner in the drawing) which has a roughly rectangular shape. The origin point of the coordinates is one corner (upper left corner in the drawing) of the holding substrate 17 having a roughly rectangular shape (holding substrate display image 17a).

The parameters input from the input boxes 92 of the fourth row are the column number and row number of the chip unit 16A (unit frame 84). The chip unit columns are the columns for which the chip unit 16A (unit frame 84) is aligned in the H axis direction. The chip unit rows are the rows for which the chip unit 16A (unit frame 84) is aligned in the W axis direction.

The parameters input from the input boxes 92 of the fifth row are the width of the W axis direction and the width of the H axis direction of the chip unit 16A (unit frame 84).

The parameters input from the input boxes 92 of the sixth row are the chip unit 16A (unit frame 84) W axis direction arrangement pitch (column pitch) and the H axis direction arrangement pitch (row pitch).

The coordinates of the reference point position of the chip unit 16A which has one corner of the holding substrate 17 as the coordinate origin point, the column number and the row number of the chip unit 16A (unit frame 84), and the column pitch and row pitch of the chip unit 16A are parameters that prescribe the position of the media unit. The chip unit 16A W axis direction width and the H axis direction width are the parameters that prescribe the shape of the media unit. The step by which the chip unit 16A W axis direction width and the H axis direction width are input is the unit shape acquiring step of acquiring the parameter values that prescribe the shape of the media unit. The step by which the coordinates of the reference point position of the chip unit 16A, the column number and the row number of the chip unit 16A (unit frame 84), and the column pitch and the row pitch of the chip unit 16A are input is the unit position acquiring step of acquiring the parameter values that prescribe the position of the media unit on the unit to be drawn on.

The input boxes 92 from the seventh row from the top to the tenth row are for inputting parameters relating to the configuration of the semiconductor chips 16 in the chip unit 16A (configuration of the chip display images 16a within the unit frame 84).

The parameters input from the input boxes 92 of the seventh row are the coordinates of the reference point position of the semiconductor chip 16 (chip display image 16a). The reference point of the semiconductor chip 16 (chip display image 16a) is one corner (the upper left corner in the drawing) of the semiconductor chip 16 (chip display image 16a) which has a roughly rectangular shape. The coordinate origin point is one corner (the upper left corner in the drawing) of the chip unit 16A (unit frame 84) which has a roughly rectangular shape.

The parameters input from the input boxes 92 of the eighth row are the column number and row number of the semiconductor chip 16 (chip display image 16a) on the chip unit 16A (unit frame 84). The columns of the semiconductor chip 16 (chip display image 16a) are columns for which the semiconductor chips 16 (chip display images 16a) are aligned in the H axis direction. The rows of the semiconductor chip 16 (chip display image 16a) are rows for which the semiconductor chips 16 (chip display images 16a) are aligned in the W axis direction.

The parameters input from the input boxes of the ninth row are the semiconductor chip 16 (chip display image 16a) W axis direction width and the H axis direction width.

The parameters input from the input boxes 92 of the tenth row are the semiconductor chip 16 (chip display image 16a) W axis direction arrangement pitch (column pitch) and the H axis direction arrangement pitch (row pitch).

The coordinates of the reference point position of the semiconductor chip having one corner of the chip unit 16A as the coordinate origin point, the column number and row number of the semiconductor chips in the chip unit 16A, and the semiconductor chip 16 column pitch and row pitch are parameters that prescribe the position of the media to be drawn on in the media unit. The semiconductor chip 16 W axis direction width and the H axis direction width correlate to the parameters that prescribe the shape of the media to be drawn on. The step by which the semiconductor chip 16 W axis direction width and the H axis direction width are input correlates to the shape acquiring step that acquires the parameter values that prescribe the shape of the media to be drawn on. The step by which the column number and row number of the semiconductor chips in the chip unit 16A, and the semiconductor chip 16 column pitch and row pitch are input is the unit internal position acquiring step that acquires the parameter values for prescribing the position of the media to be drawn on in the media unit. The step consisting of the unit position acquiring step and the unit internal position acquiring step described above correlates to the position acquiring step of acquiring the parameter values for prescribing the position of the media to be drawn on in the unit to be drawn on.

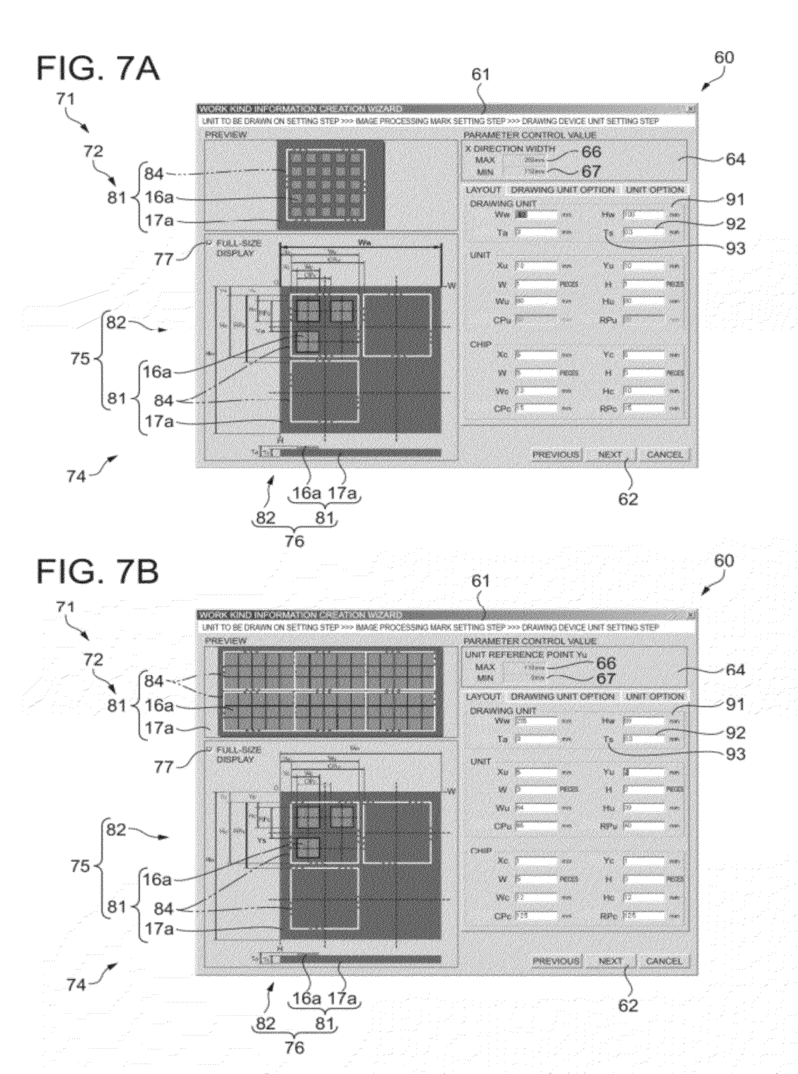

FIG. 7A is a descriptive diagram showing an example of the setting screen in a state for which the input box is selected. With the setting screen 60 shown in FIG. 7A, the input box 92 of the first row and first column for inputting the value of the W axis direction width of the holding substrate 17 is selected. The selected input box 92 is in an input state for which it is possible to input numerical values from a keyboard or the like, for example. With the input box 92 which is selected and in an input state, for example, it is possible to distinguish that the concerned input box 92 is selected and in an input state by reversing the color of the background and numbers of the part for which the numerical values are displayed.

With the parameter position screen 74, the part indicating the W axis direction width of the holding substrate 17 on the parameter display unit 82 of the flat display screen 75 is shown with highlighted display. To do highlighted display, for example, the color tone is changed, the shade is changed, or the text and line thickness is changed.

On the limit value display screen 64, the maximum value of the W axis direction width of the holding substrate 17 is displayed on the maximum value display unit 66, and the minimum value is displayed on the minimum value display unit 67. The maximum value of the W axis direction width of the holding substrate 17 in this case is, for example, the maximum value of work that can be drawn with the droplet discharge device 101.

As described above, the input box 92 selection can be implemented by clicking the selected input box 92 or the box display 93 corresponding to the concerned input box 92. It is also possible to select the parameters (input box 92) corresponding to the concerned display by clicking the display of the parameter display unit 82.

FIG. 7B is a descriptive diagram showing an example of the setting screen in a state with parameter input completed. The setting screen 60 shown in FIG. 7B is an example of a setting screen 60 in a state with input of the 20 parameters completed. Displayed on the preview screen 72 are the chip display image 16a, the holding substrate display image 17a, and the unit frame 84 in shapes reflecting the input parameter values.

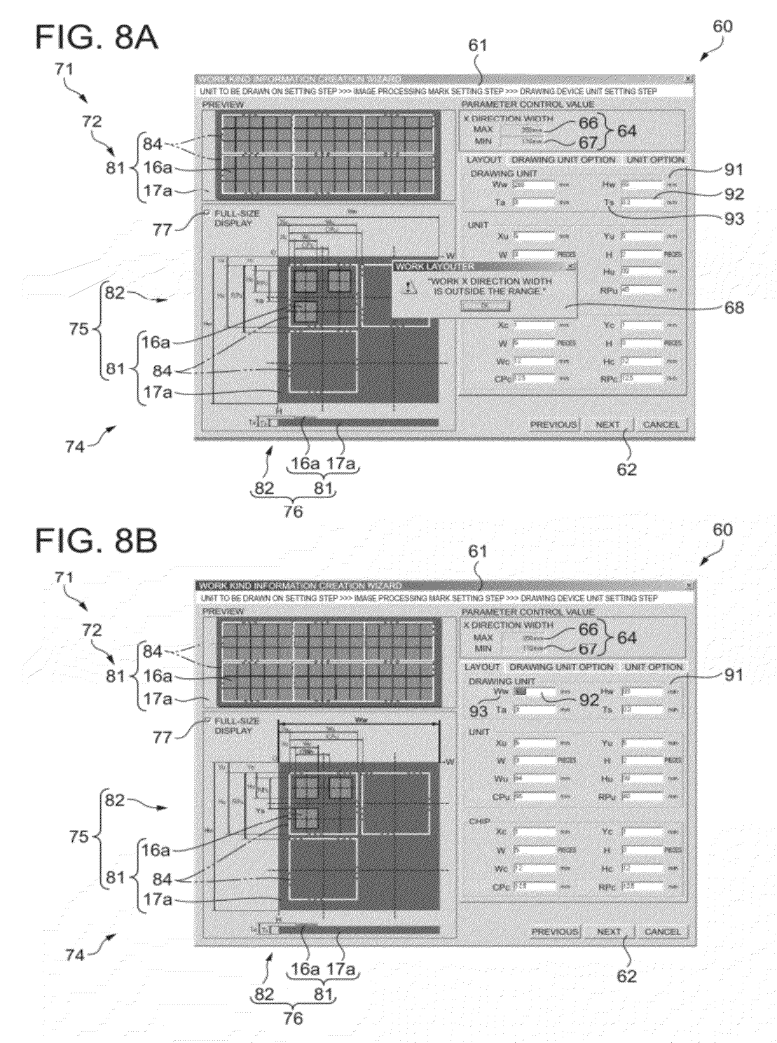

When the numerical values input to the input boxes 92 exceed the range from the minimum value to the maximum value displayed on the limit value display screen 64, the warning screen 68 is displayed. FIG. 8 is a descriptive diagram showing an example of the display of the setting screen or the like when the warning screen is displayed. FIG. 8A is a descriptive diagram showing an example of the display of a setting screen on which the warning screen is displayed, and FIG. 8B is a descriptive diagram showing an example of the display of a setting screen for which the warning screen has been deleted.

With the setting screen 60 shown in FIG. 8A, 260 mm has been input for the W axis direction width of the holding substrate 17 for which the maximum value displayed on the maximum value display unit 66 is 250 mm. When the ENTER key or the like is pressed to do the next input, as shown in FIG. 8A, the warning screen 68 is displayed overlapping the setting screen 60. Noted in the warning screen 68 shown in FIG. 8A is a comment notifying the reason that the value is unsuitable.

The displayed warning screen 68 is deleted by clicking the “OK” button of the warning screen 68 as shown in FIG. 8B. At this time, the numerical value of the input box 92 of the W axis direction width of the holding substrate 17 (input box 92 of the first row, first column) shown in FIG. 8B is 240 mm. 240 is the numerical value that was input before 260, which was the subject of the warning, was input.

The warning screen 68 shown in FIG. 8A correlates to the warning information. The step of displaying the warning screen 68 correlates to the mismatch warning step.

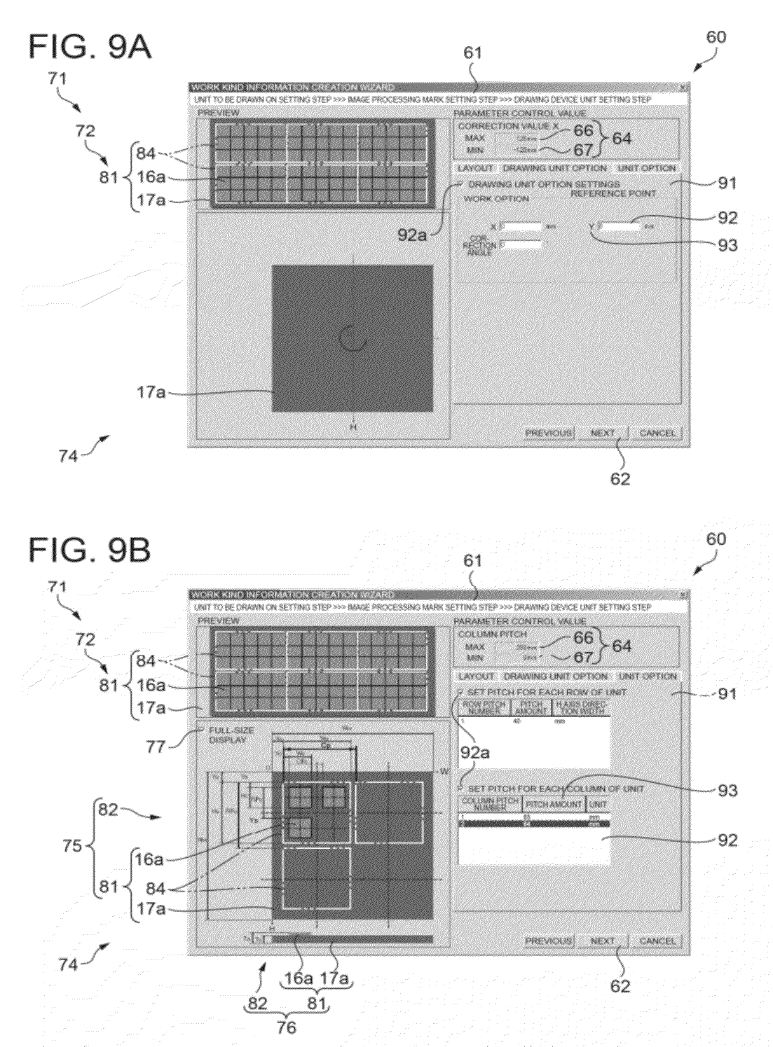

After step S21 of FIG. 5, at step S22, the drawing unit option settings are implemented. FIG. 9A is a descriptive diagram showing the setting screen for implementing the drawing unit option settings. As shown in FIG. 9A, with the setting screen 60 for implementing the drawing unit option settings, an option selection box 92a is formed on the input screen 91. The option selection box 92a is a check box, and by checking this, it is possible to set options. With the example shown in FIG. 9A, it is possible to do holding substrate 17 position correction and tilt correction. The holding substrate display image 17a as well as the position correction and tilt correction reference axis are illustrated in the parameter position screen 74.

After step S22 in FIG. 5, at step S23, the chip unit 16A option settings are implemented. FIG. 9B is a descriptive drawing showing the setting screen for implementing the chip unit option settings. As shown in FIG. 9B, with the setting screen 60 for implementing the option settings of the chip unit, an option selection box 92a is formed on the input screen 91. The option selection box 92a is a check box, and by checking this, it is possible to set options. With the example shown in FIG. 9B, it is possible to individually set the pitch interval for each row or column of the chip unit 16A. On the parameter position screen 74, the same shape as with the layout settings is illustrated.

After step S23 of FIG. 5, at step S24, the process shifts from the step of setting the unit to be drawn on to the step of setting the image processing mark. As with the setting screen 60 shown in FIG. 7B, by clicking the step shift button 62 on the setting screen 60 in a state for implementing the step of setting the unit to be drawn on, the process shifts from the step of setting the unit to be drawn on to the step of setting the image processing mark. At this time, when there is a mismatch in the parameter value input with the step of setting the unit to be drawn on, the warning screen 68 is displayed.

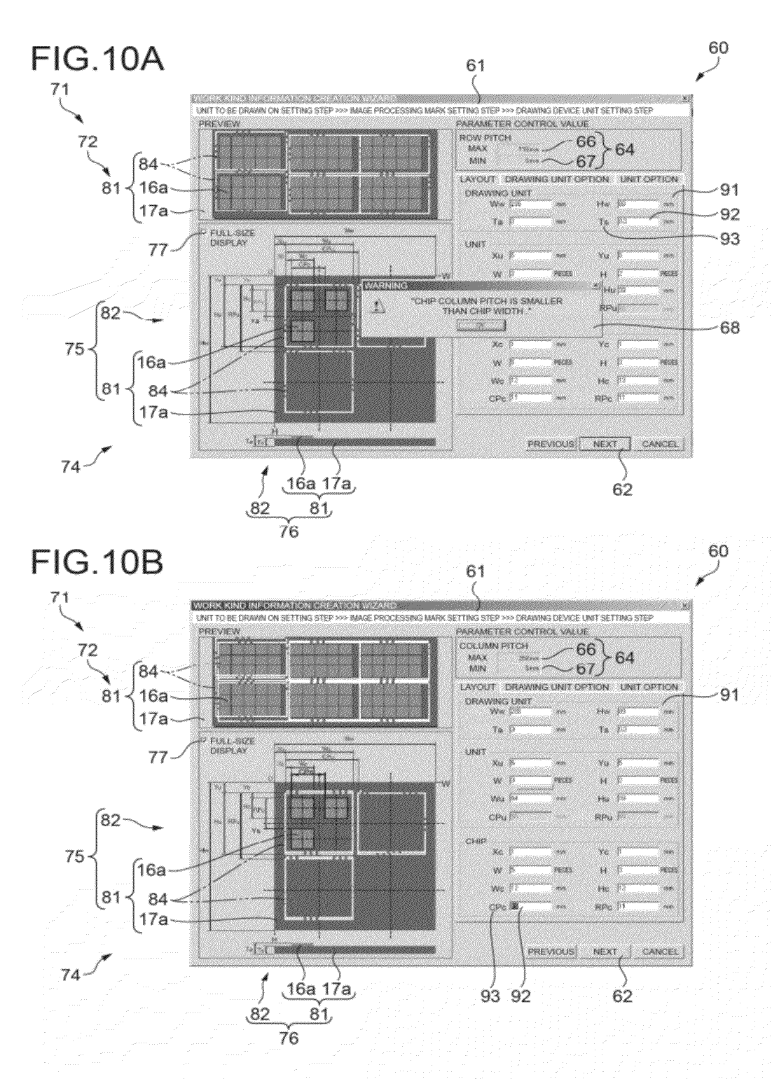

FIG. 10 is a descriptive drawing showing an example of display of a setting screen or the like when a warning screen is displayed. FIG. 10A is a descriptive diagram showing an example of a setting screen on which a warning screen is displayed. FIG. 10B is a descriptive diagram showing an example of a setting screen for which the warning screen is deleted. With cases when there are mismatches in the input parameter values, there are cases when the respective parameter values are suitable values as parameter values, but they are not suitable when they are combined. For example, there are cases such as when the size and arrangement pitch of the semiconductor chips 16 are suitable, but the semiconductor chip 16 column or row length is longer than the holding substrate 17 width or length.

With the setting screen 60 shown in FIG. 10A, the semiconductor chip 16 W axis direction and H axis direction width is 12 mm, but the column pitch and row pitch are set to 11 mm. Because of this, the warning screen 68 is displayed. Noted on the warning screen 68 shown in FIG. 10A is a comment notifying the reason that the value is unsuitable.

By clicking the “OK” button that the warning screen 68 has, the displayed warning screen 68 is deleted as shown in FIG. 10 (b). At this time, the semiconductor chip 16 column pitch input box 92 (input box 92 of the tenth row, first column) shown in FIG. 10B is in a selected state. When a new value is input to the concerned input box 92, the semiconductor chip 16 row pitch input box 92 (input box 92 of the tenth row, second column) which is another input box 92 for which an unsuitable value was input is in a selected state.

The warning screen 68 shown in FIG. 10A correlates to the warning information. The step of displaying the warning screen 68 correlates to the mismatch warning step.

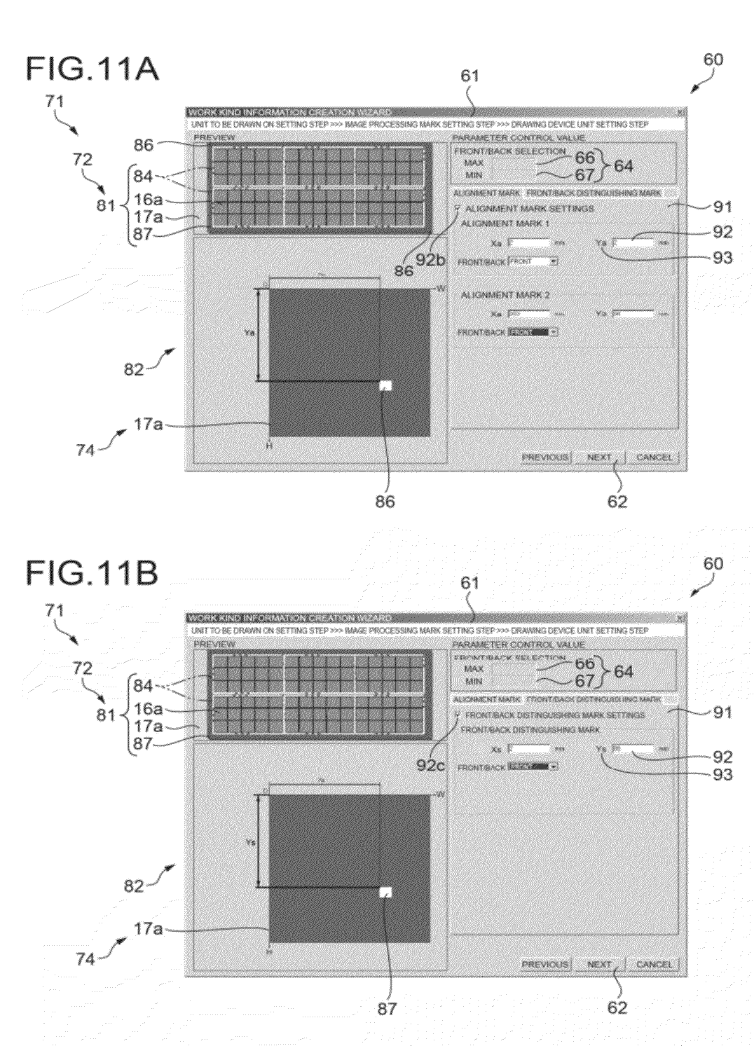

After step S24 of FIG. 5, next at step S25, setting of the alignment mark position is implemented. FIG. 11A is a descriptive diagram showing the setting screen for implementing the position setting of the alignment marks. As shown in FIG. 11A, on the setting screen 60 for implementing the alignment mark position setting, an alignment mark selection box 92b is formed on the input screen 91. The alignment mark selection box 92b is a check box, and when this is checked, it is possible to do setting of the alignment mark position. With the example shown in FIG. 11A, it is possible to set the position of two alignment marks, and the surface on which the alignment mark will be drawn on the holding substrate 17. The surface on which the semiconductor chips 16 are placed on the holding substrate is the front surface, and the surface of the side opposite to that is the back surface. Displayed on the parameter position screen 74 is the parameter display unit 82 that shows the holding substrate display image 17a, the alignment mark image 86, and the alignment mark image 86 position. On the preview screen 72, two alignment mark images 86 are displayed at positions determined by the values input to the input screen 91.

The alignment marks are used when implementing alignment of the chip drawing unit 15 placed on the processing device. By the alignment marks being recognized by the imaging device, alignment of the chip drawing unit 15 placed on the processing device is implemented.

After step S25 of FIG. 5, next at step S26, position setting of the front/back distinguishing marks is implemented. FIG. 11B is a descriptive drawing showing the setting screen for implementing the position setting of the front/back distinguishing marks. As shown in FIG. 11B, with the setting screen 60 for implementing the position setting of the front/back distinguishing marks, a front/back distinguishing mark selection box 92c is formed on the input screen 91. With the example shown in FIG. 11B, it is possible to set the position of the front/back distinguishing mark and the surface on which the front/back distinguishing mark is drawn on the holding substrate 17. The surface on which the semiconductor chip 16 is placed with the holding substrate 17 is the front surface, and the surface of the side opposite to that is the back surface. The parameter display unit 82 which shows the holding substrate display image 17a, the front/back distinguishing mark image 87, and the front/back distinguishing mark image 87 position is displayed on the parameter position screen 74. On the preview screen 72, the front/back distinguishing mark image 87 is displayed at the position determined by the values input to the input screen 91.

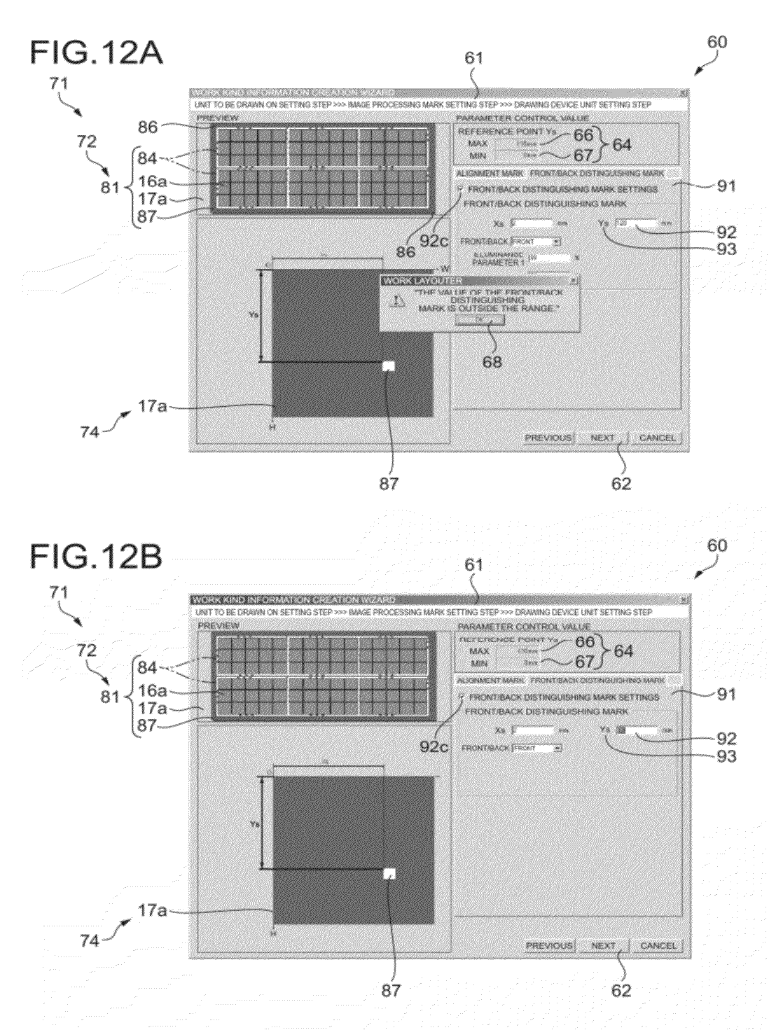

When the numerical values input to the input box 92 exceed the range from the minimum value to the maximum value displayed on the limit value display screen 64, the warning screen 68 is displayed. FIG. 12 is a descriptive diagram showing an example of display of a setting screen or the like when the warning screen is displayed. FIG. 12A is a descriptive diagram showing an example of display of a setting screen on which the warning screen is displayed, and FIG. 12B is a descriptive diagram showing an example of display of a setting screen for which the warning screen has been deleted.

With the setting screen 60 shown in FIG. 12A, 120 mm is input for the position of the H axis direction of the reference point for which the maximum value displayed on the maximum value display unit 66 is 110 mm. When the ENTER key or the like is pressed to do the next input, as shown in FIG. 12A, the warning screen 68 is displayed overlapping the setting screen 60. A comment notifying that the reason is the value is unsuitable is noted on the warning screen 68 shown in FIG. 12A.

As shown in FIG. 12B, when the “OK” button of the warning screen 68 is clicked, the displayed warning screen 68 is deleted. At this time, the numerical value of the input box 92 of the H axis direction position of the front/back distinguishing mark (input box 92 of the first row, second column) shown in FIG. 12B is 86 mm. 86 is the numerical value that had been input before 120 which is the subject of the warning was input.

The warning screen 68 shown in FIG. 12A correlates to the warning information. The step of displaying the warning screen 68 correlates to the mismatch warning step.

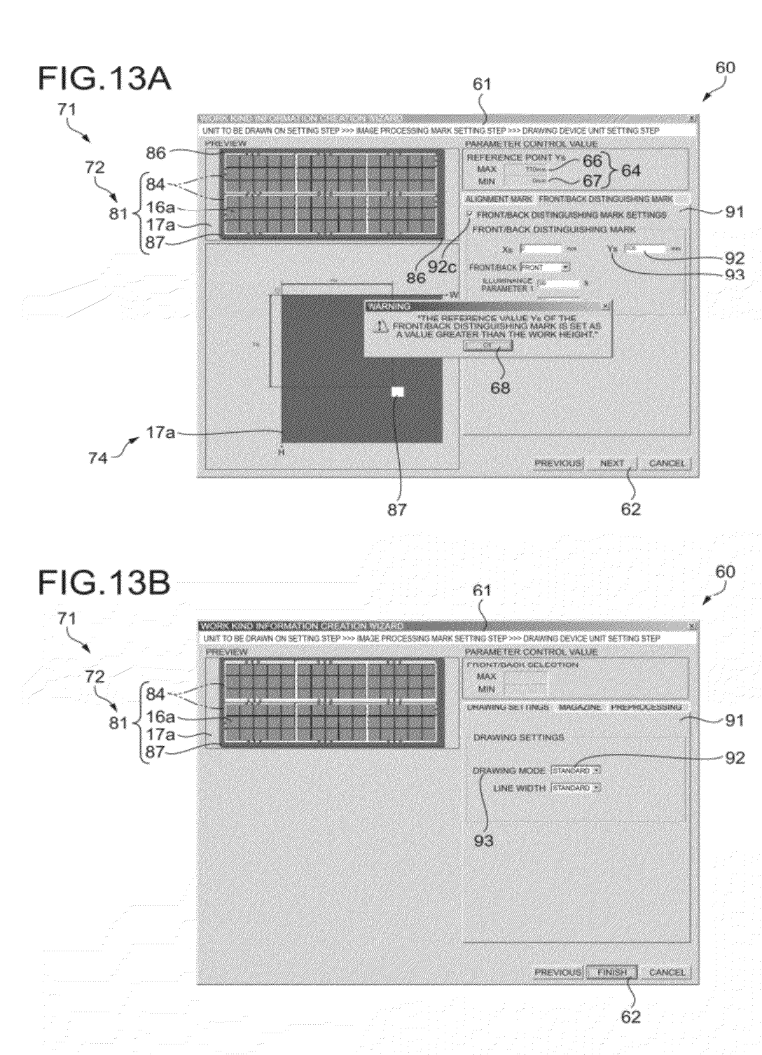

After step S26 of FIG. 5, next at step S27, the process shifts from the step of setting the image processing mark to the step of setting the drawing device unit. As with the setting screen 60 shown in FIG. 11, by clicking the step shift button 62 on the setting screen 60 in a state for implementing the image processing mark setting step, the process shifts from the step of setting the image processing mark to the step of setting the drawing device unit. At this time, when there is a mismatch with the parameter value that was input with the image processing mark setting step, as shown in FIG. 13A, the warning screen 68 is displayed. FIG. 13A is a descriptive diagram showing an example of display of a setting screen on which a warning screen is displayed.

When there is a mismatch with the parameter value that has been input, there are cases when the respective parameter values are suitable values as parameter values, but are not suitable when combined. For example, with the example shown in FIG. 13A, there are cases when the value prescribing the position of the front/back distinguishing mark is a suitable value (100) in the range from the minimum value (0) to the maximum value (110) displayed on the limit value display screen 64, but it is a value that does not fit the width (89) of the holding substrate 17 set with the step of setting the unit to be drawn on. On the warning screen 68 is noted a comment notifying the reason that this is an unsuitable value. By clicking the “OK” button of the warning screen 68, the displayed warning screen 68 is deleted. At this time, the same as when explained when referring to FIG. 10B, the input box 92 for which the front/back distinguishing mark position is input is in a selected state. When a new value is input to the concerned input box 92, the other input box 92 for which the unsuitable value was input is in a selected state.

The warning screen 68 shown in FIG. 13A correlates to the warning information. The step of displaying the warning screen 68 correlates to the mismatch warning step.

After step S27 of FIG. 5, next at step S28, the drawing setting step of the drawing device unit setting step is implemented. FIG. 13B is a descriptive diagram showing the setting screen when setting the drawing mode for the droplet discharge device. As shown in FIG. 13B, with the drawing setting step, the drawing mode is set for the droplet discharge device 101.

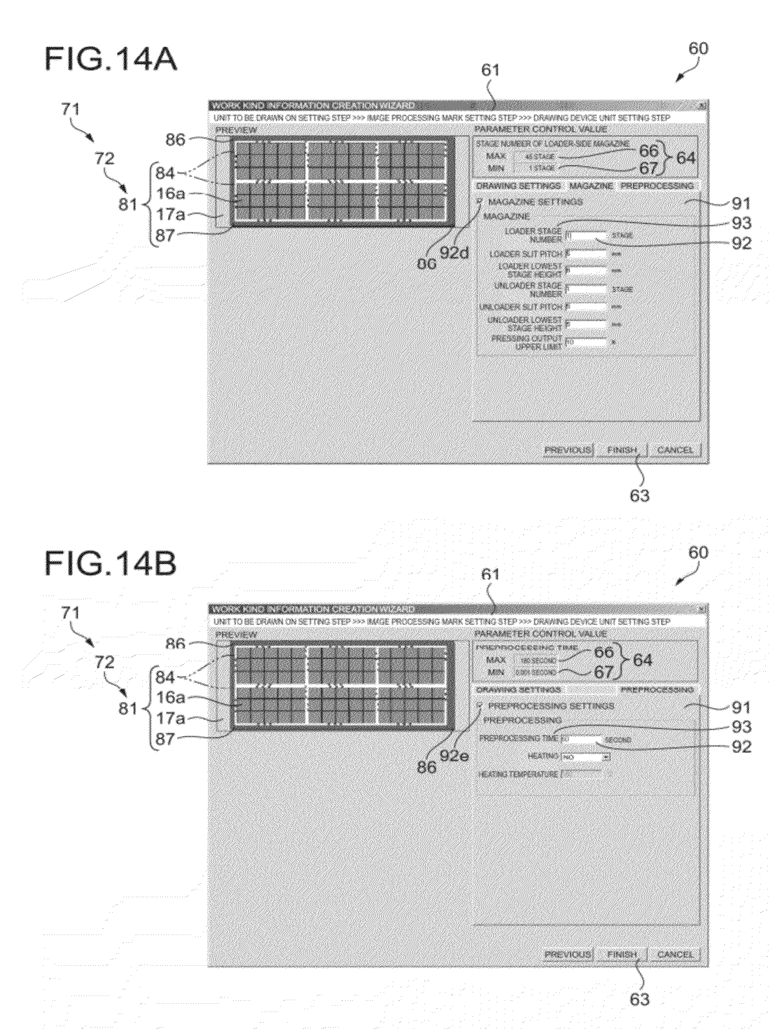

After step S28 of FIG. 5, next at step S29, the magazine setting step of the step of setting the drawing device unit is implemented. FIG. 14A is a descriptive diagram showing the setting screen when setting the parameter values relating to the magazine. As shown in FIG. 14A, with the magazine setting step the parameter values relating to the magazine are set. As shown in FIG. 14A, with the setting screen 60 for implementing the magazine setting step, a magazine setting selection box 92d is formed on the input screen 91. The magazine setting selection box 92d is a check box, and by checking this, it is possible to do magazine settings. As described above, the chip drawing unit 15 or the like is mounted in a specified magazine. By loading the magazine in which the chip drawing unit 15 or the like is mounted in the loading device 105, the chip drawing unit 15 or the like is supplied to the drawing device unit 100. With the magazine setting step, parameter values are set which relate to the magazine used when drawing the generated chip drawing image 150a.

After step S29 of FIG. 5, next at step S30, the preprocessing setting step of the drawing device unit setting step is implemented. FIG. 14B is a descriptive diagram showing the setting screen for implementing the preprocessing setting step. As shown in FIG. 14B, with the setting screen 60 for implementing the preprocessing setting step, a preprocessing setting selection box 92e is formed on the input screen 91. The preprocessing setting selection box 92e is a check box, and by checking this, preprocessing setting is possible. As described above, the preprocessing device 103 implements preprocessing to put the chip drawing unit 15 or the like in the optimal state for drawing using the droplet discharge device 101. With the preprocessing setting step, parameter values relating to various conditions of the concerned preprocessing are input.

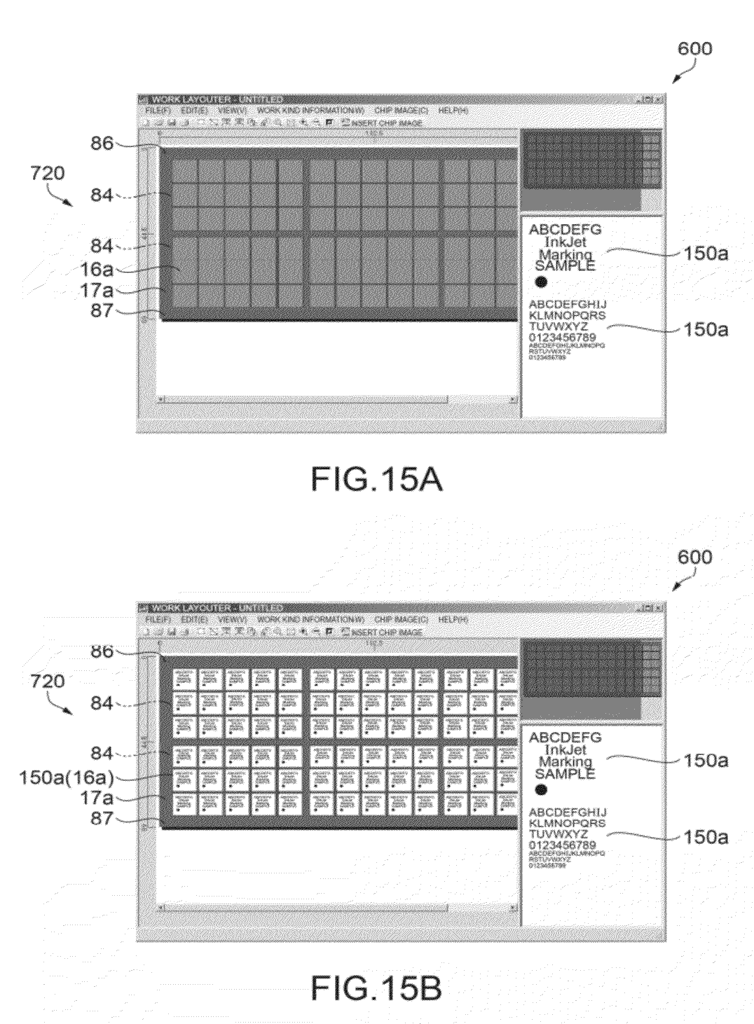

After step S30 of FIG. 5, next at step S31, the process shifts to the chip drawing pasting step. By clicking the finish button 63 such as shown in FIG. 14 or the like, as shown in FIG. 15A, an image pasting screen 600 for implementing the chip image pasting step is displayed.

When the finish button 63 is clicked, verification is done of whether or not there is a mismatch with each of the parameter values input up to then. When there is a mismatch, the warning screen 68 like that shown in FIG. 10 or the like is displayed, and a mismatch revision is prompted. When there is no mismatch, by the finish button 63 being clicked, each of the input parameter values is set.

The warning screen 68 correlates to the warning information. The step of displaying the warning screen 68 correlates to the mismatch warning step.

After step S31 of FIG. 5, next at step S32, the chip image pasting step is implemented. FIG. 15 is a descriptive diagram showing an image pasting screen when implementing the chip pasting step. FIG. 15A is a descriptive diagram showing the image pasting screen before pasting the image of the chip image, and FIG. 15B is a descriptive drawing showing the image pasting screen with the image of the chip image pasted.

With the chip image pasting step, initially, the chip image acquiring step is implemented. By implementing the chip image acquiring step, as shown in FIG. 15A, the image of the chip image 150a is inserted in the image pasting screen 600. With the image pasting screen 600 shown in FIG. 15A, two types of image of the chip image 150a are inserted.

Next, with the chip image pasting step, with the image pasting screen 600 like that shown in FIG. 15A, the selected image of the chip image 150a is pasted onto the chip display image 16a selected in the layout display screen 720. By doing this, as shown in FIG. 15B, a drawing image is formed by the specified image of the chip image 150a being pasted onto the chip display image 16a for printing the concerned image of the chip image 150a.

The chip image pasting step of step S32 correlates to the step of prescribing the media image position.

After step S32 of FIG. 5, next at step S33, the drawing image data is output. The drawing image data is electronic data, and it is output from the input/output device 52 of the image data generating device 50. FIG. 16 is a descriptive diagram showing an example of the generated drawing image data. The drawing image data for which a portion is shown in FIG. 16 is output as electronic data.

Step S33 is implemented, and the step of generating drawing image data is completed.

The electronic data of the drawing image data is input to the drawing unit control device 107 of the drawing device unit 100. The drawing unit control device 107 implements drawing of the chip image such as shat shown in FIG. 15B according to the input drawing image data.

Following, we will describe the effect of this embodiment. With this embodiment, the following effects are obtained.

(1) With the image data generating device 50, various setting screens used for generating drawing image data are displayed on the screen display unit 53a. By the operator who is generating drawing image data using the image data generating device 50 inputting the various parameter setting values for generating the drawing image data by following the displayed setting screen, it is possible to easily and recognize the parameters correctly during input. By doing this, it is possible to suppress erroneous operation.

(2) The setting screen 60 is equipped with an auxiliary display screen 71 and an input screen 91. It is possible to input parameter values from the input screen 91 while confirming with the auxiliary display screen 71, so it is possible to easily recognize the parameters to be input correctly. By doing this, it is possible to suppress errors with the parameters being input.

(3) In the auxiliary display screen 71, the parameters input from the input screen 91 are displayed as two-dimensional shapes such as a drawing. By doing this, it is possible to visually recognize the parameter values as a two-dimensional shape displayed on the auxiliary display screen unit. Being able to visually recognize the parameter values as a two-dimensional shape makes it possible to make the parameter values easy to confirm.

(4) The auxiliary display screen 71 is equipped with a parameter position screen 74. The parameter position screen 74 is equipped with a graphic display unit 81 and a parameter display unit 82. The graphic display unit 81 displays a schematic shape of the chip drawing unit 15 such as the chip display image 16a, and the parameter display unit 82 shows the part corresponding to each parameter in the graphic display unit 81. This makes it possible to clearly illustrate each parameter.

(5) The parameter position screen 74 is equipped with a display selection box 77. By removing the check from the display selection box 77, only the selected parameters are displayed in the parameter display unit 82. This makes it possible to make it easier to know the selected parameters.

(6) The auxiliary display screen 71 is equipped with the preview screen 72. On the preview screen 72, the shape of the chip display image 16a, the holding substrate display image 17a, and the unit frame 84 are shapes corresponding to the parameter values input in the input screen 91, and the image of the chip drawing unit 15 displayed on the preview screen 72 is a reduced image or enlarged image of the chip drawing unit 15 of a shape corresponding to the input parameter values. By doing this, it is possible to confirm the input parameter values as shapes.

(7) The setting screen 60 is equipped with a limit value display screen 64. On the limit value display screen 64, the maximum value and minimum value for the parameters corresponding to the input box 92 selected by the input screen 91 are displayed. By equipping a limit value display screen 64, it is possible to easily recognize the maximum value and minimum value of the parameters being input. By doing this, it is possible to suppress inputting of values that exceed the settable maximum value or minimum value.

(8) An input box 92 for inputting parameters relating to the configuration of the chip unit 16A for the chip drawing unit 15 and an input box 92 for inputting parameters relating to the configuration of the semiconductor chips 16 for the chip unit 16A (configuration of the chip display images 16a within the unit frame 84) are equipped. By doing this, it is possible to handle the semiconductor chips 16 as units of chip unit 16A which are a collection of semiconductor chips 16. By handling as chip unit 16A units, it is possible to reduce the volume of data handled compared to when handling each individual semiconductor chip 16.

(9) When the numerical values input to the input box 92 exceed the range from the minimum value to the maximum value displayed on the limit value display screen 64, the warning screen 68 is displayed. This makes it possible to essentially eliminate inputting of values that exceed the maximum value or the minimum value.

(10) When the warning screen 68, that is displayed when the range of the minimum value to the maximum value is exceeded and is displayed on the limit value display screen 64, is deleted, the numerical value of the input box 92 that was subject to the warning becomes the numerical value that had been input before the numerical value that was subject to the warning was input. This makes it possible to essentially eliminate inputting of the numerical value subject to the warning as is.

(11) A comment notifying that the reason is an unsuitable value is noted on the warning screen 68 that is displayed when the range from the minimum value to the maximum value displayed on the limit value display screen 64 is exceeded. This makes it possible to easily select a suitable value by avoiding the reason of a value being unsuitable.

(12) By clicking the step shift button 62, when shifting from the step of setting the unit to be drawn on to the step of setting the image processing mark, the warning screen 68 is displayed when there is a mismatch in the parameter values input with the step of setting the unit to be drawn on. This makes it possible to essentially eliminate ending the step of setting the unit to be drawn on in a state when there is a mismatch in the parameter values input with the step of setting the unit to be drawn on.

(13) A comment notifying the reason that the parameter value is a mismatch is noted on the warning screen 68 displayed when there is a mismatch in the parameter values input with the process of setting the unit to be drawn on. This makes it possible to easily select a suitable value while avoiding causing a mismatch.

(14) When the warning screen 68 that was displayed when there was a mismatch in the parameter values input with the process of setting the unit to be drawn on is deleted, the input box 92 for which the parameter value mismatch occurred is in a selected state. By doing this, it is possible to make it easier to recognize parameters for which a mismatch has occurred, and to easily correct the unsuitable values.

(15) The setting screen 60 is equipped with a finish button 63, and by clicking the finish button, the process shifts to the chip image pasting step. At this time, by the finish button 63 being clicked, each of the input parameter values is set. By doing this, it is possible to clarify that the setting is finished, so it is possible to suppress shifting to the chip image pasting step in a state when setting is not finished.

(16) The setting screen 60 is equipped with a finish button 63, and by clicking the finish button 63, the process shifts to the chip image pasting step. At this time, when there is a mismatch with the parameter values input up to now, the warning screen 68 is displayed. This makes it possible to essentially eliminate shifting to the chip image pasting step in a state when there is a mismatch in the input parameter values.

(17) When the finish button 63 is clicked, a comment notifying the reason that there is a mismatch in the parameter value is noted on the warning screen 68 displayed when there is a mismatch in the parameter values input using the setting screen 60. This makes it possible to make it easy to select a suitable value by avoiding the cause of a mismatch.

(18) When the finish button 63 is clicked, when the warning screen 68 which is displayed when there is a mismatch in the parameter values input using the setting screen 60 is deleted, the input box 92 for which the mismatch occurred with the parameter value is in a selected state. This makes it possible to make it easy to recognize the parameter for which the mismatch occurred, and to make it easy to correct the unsuitable value.

(19) The input box 92 which is in a selected input state for example has the numerical value display part background and number color reversed. This makes it possible to clarify that the concerned input box 92 is selected and in an input state.

(20) With the parameter position screen 74, the part corresponding to the selected parameters in the flat display screen 75 or the thickness display screen 76 parameter display unit 82 for example has the color changed or is displayed as highlighted. This makes it possible to visually recognize the selected parameters in a two-dimensional shape of the flat display screen 75 or the thickness display screen 76.

(21) By clicking the display of the parameter display unit 82 on the parameter position screen 74, it is possible to select the parameter corresponding to the concerned display (input box 92). This makes it possible to select parameters (input box 92) while visually confirming with the two-dimensional shape of the flat display screen 75 or the thickness display screen 76.

(22) The thickness of the chip drawing unit 15 (thickness for which the thickness of the semiconductor chip 16 is added to the thickness of the holding substrate 17) is set as a parameter that can be input. This makes it possible to add the thickness information of the chip drawing unit 15 to the generated drawing image data. The thickness information of the chip drawing unit 15 can be useful for precisely setting the interval with the droplet discharge head 20 when drawing with the chip drawing unit 15 set in the droplet discharge device 101, for example.

(23) The thickness of the holding substrate 17 is set as a parameter that can be input. By doing this, the thickness information of the holding substrate 17 can be added to the generated drawing image data. The thickness information of the holding substrate 17 is useful for precisely setting the alignment mark or front/back distinguishing mark when the chip drawing unit 15 is set in the droplet discharge device 101, for example.

Also, when the alignment mark or front/back distinguishing mark is optically recognized, this is useful for specifying the position at which to match the focus (position of the surface on which the alignment mark or front/back distinguishing mark is formed).

(24) The drawing device unit 100 is equipped with a droplet discharge device 101, a transfer robot 102, a preprocessing device 103, a temperature regulating device 104a, a temperature regulating device 104b, a loading device 105, an unloading device 106, and a drawing unit control device 107. The image data generating device 50 has a function of generating drawing image data for drawing the chip drawing image 150A using the drawing device unit 100. By doing this, by inputting the drawing image data generated by the image data generating device 50 and supplying it to the chip drawing unit 15, it is possible to draw the chip image 150 on the semiconductor chip 16.

(25) With the image data generating device 50, the position of the chip image 150 on the chip drawing image 150A is prescribed by prescribing the position of the semiconductor chip 16 on the chip drawing unit 15. The chip drawing unit 15 is the subject to be drawn and exists as a tangible object. Because of this, when implementing the input operation of the parameter values that prescribe the position of the chip image 150 in the image data generating device 50, it is possible to associate the input parameter values with the chip drawing unit 15 and make it easy to recognize that as a concrete shape.

(26) An input box 92 for inputting parameters relating to the configuration of the chip unit 16A for the chip drawing unit 15 and an input box 92 for inputting parameters relating to the configuration of the semiconductor chip 16 for the chip unit 16A (configuration of the chip display image 16a within the unit frame 84) are provided. By doing this, it is possible to handle the semiconductor chips 16 as units of the chip unit 16A which is a collection of semiconductor chips 16. By handling with chip unit 16A units, it is possible to reduce the volume of data handled compared to when handling each individual semiconductor chip 16.

Above, we described preferred embodiments while referring to the attached drawings, but the preferred embodiments are not limited to the aforementioned embodiments. Various modifications can of course be made to the embodiments without deviating from the scope of the invention. For example, the following types of modifications are possible.

### First Modification Example

In the embodiments described above, the drawing device unit 100 that draws the chip drawing image 150A according to the drawing image data of the chip drawing image 150A is equipped with a droplet discharge device 101 equipped with an inkjet type droplet discharge head 20. However, it is not essential for the device that implements drawing to be a device equipped with an inkjet type discharge head. The device for implementing drawing can also be a device equipped with a discharge head of a type other than the inkjet type. The discharge head also does not have a fluid body as the droplets, but can also be a discharge head of a type that does continuous discharge.

Also, the device for implementing drawing does not have to be a device that forms images using a fluid body. It is also possible to be a device that forms images by radiating laser light and changing the state of the part on which the laser light was radiated on the unit to be drawn on.

### Second Modification Example

In the embodiments described above, the image data generating device 50 was a separate device from the drawing device unit 100, but it is not essential that the data generating device be a separate unit from the image forming device. It is also possible for a drawing control device such as the drawing unit control device 107 to have a configuration including a data generating device such as the image data generating device 50. It is also possible to have a configuration with which the drawing control device and the data generating device are electrically connected and the image data is sent directly from the data generating device to the drawing control device.

### Third Modification Example

In the embodiments described above, the image data generating device 50 had the function of generating drawing image data for drawing the chip drawing image 150A or the like using the drawing device unit 100. Therefore, it was possible to also generate data relating to the preprocessing process or the supply or removal of the media to be drawn on. However, the drawing image data generated by the data generating device does not have to contain up to the data relating to the preprocessing process or the supply or removal of the media to be drawn on. The data generating device can also be a device equipped only with the function of being able to form the necessary data for operating a drawing device such as the droplet discharge device 101.

### Fourth Modification Example

In the embodiments described above, we described an example of the semiconductor chip 16 as the media to be drawn on, but the media to be drawn on is not limited to being a semiconductor chip. When images are drawn on the respective media to be drawn on for a large number of media to be drawn on, as long as it is media to be drawn on for which it is possible to draw efficiently by implementing drawing roughly simultaneously with media to be drawn on for which the data generating device, the data generating method, or the program described above optimally function, any kind of media to be drawn on is acceptable. For example, even in the case of implementing marking on a packaged semiconductor device, printing on a label, decorations on various containers, or printing or the like of metal wiring on a wiring board, it is possible to suitably apply the data generating device, the data generating method, or the programs described above.

### Fifth Modification Example

In the embodiments described above, the limit value display screen 64 was equipped with a maximum value display unit 66 for displaying the parameter maximum value and a minimum value display unit 67 for displaying the minimum value, but it is not essential to display both the maximum value and the minimum value on the limit value display screen unit. It is also possible to use a constitution or method that displays only one or the other of the maximum value or the minimum value on the limit value display screen unit.

### Sixth Modification Example

In the embodiments described above, when a parameter was selected, at the input screen 91, the input box 92 which is selected and in an input state for example had the part for displaying the numerical values background and number colors reversed, and it was possible to distinguish that the concerned input box 92 was selected and in an input state. To display that the input box 92 is selected and in an input state, it is also possible to highlight the box display 93. Highlighting the input box display such as the box display 93 can be implemented for example by increasing the size of the text, making the bold line constituting the text thicker, or changing the text color.

### Seventh Modification Example

In the embodiments described above, as the unit to be drawn on, we described an example of a chip drawing unit 15 for which the semiconductor chips 16 were formed aligned on the holding substrate 17. However, the unit to be drawn on is not limited to being an item for which media to be drawn on are arranged on a substrate such as the holding substrate 17. The unit to be drawn on can also be a collection of media to be drawn on before being divided into individual media to be drawn on such as a wafer for which semiconductor chips are formed partitioned.

### Eighth Modification Example

In the embodiments described above, with the image data generating device 50, various types of setting screens used for generating drawing image data were displayed on the screen display unit 53a. However, to input and acquire parameter values, it is not essential to display a screen such as for displaying the parameters as shapes such as with the auxiliary display screen 71. It is also possible to display the parameters for inputting values with another method. For example, it is possible to have a configuration for aiding input of the parameter values by displaying parameters such as with the input screen 91. It is also possible to have a configuration that notifies the parameters for which values have been input using sound.

### Ninth Modification Example

In the embodiments described above, the position of the chip unit 16A on the chip drawing unit 15 was prescribed using the coordinates of the position of the reference point of the chip unit 15A, the column number and row number of the chip unit 16A (unit frame 84), and the column pitch and row pitch of the chip unit 16A. In combination with this, the position of the semiconductor chips 16 on the chip unit 16A was prescribed by the coordinates of the position of the reference point of the semiconductor chip 16 which has one corner of the chip unit 16A as the coordinate origin point, the column number and row number of the semiconductor chip 16 on the chip unit 16A, and the column pitch and row pitch of the semiconductor chips 16. Specifically, together with prescribing the position of the chip unit 16A on the chip drawing unit 16, the position of the semiconductor chips 16 on the chip drawing unit 15 was prescribed by prescribing the position of the semiconductor chips 16 on the chip unit 16A. However, to prescribe the position of the media to be drawn on, it is not essential to set a media unit such as the chip unit 16A. It is also possible to directly prescribe the position of the media to be drawn on with the unit to be drawn on. In the case of directly prescribing the position of the media to be drawn on with the unit to be drawn on, the parameters that directly prescribe the position of the media to be drawn on correlate to the parameters that prescribe the position of the media to be drawn on with the unit to be drawn on.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A data generating method for generating image data of a drawing image for drawing on a drawing unit to be drawn on equipped with a plurality of media to be drawn on, the data generating method comprising:
inputting values of parameters for prescribing the image data to an input screen unit having an input box configured and arranged to input the values of the parameters; and
displaying the input values of the parameters on an auxiliary display screen unit configured and arranged to display the values of the parameters as two-dimensional shapes.

2. The data generating method according to claim 1, wherein
the parameters include a shape parameter for prescribing a shape of the media and an arrangement parameter for prescribing an arrangement of the media,
the auxiliary display screen unit has a preview screen unit configured and arranged to display the two-dimensional shapes representing the shape and an arrangement position of the media, and
the displaying of the input values includes displaying the two-dimensional shapes formed according to the value of the shape parameter or the value of the arrangement parameter on the preview screen unit.

3. The data generating method according to claim 1, wherein
the input screen unit includes a substrate thickness input screen unit configured and arranged to input a thickness of a substrate of the drawing unit supporting the media.

4. The data generating method according to claim 1, wherein
the auxiliary display screen unit has a parameter position display screen unit configured and arranged to indicate a part to which the parameters correspond in the two-dimensional shapes showing a shape and an arrangement position of the media.

5. The data generating method according to claim 4, wherein
at least one of the input box configured and arranged to input the values of the parameters corresponding to the selected position and a display of the input box is highlighted in correspondence to a selection of a specified position on the parameter position display screen unit.

6. The data generating method according to claim 1, further comprising
sending warning information when there is a mismatch in acquired values of the parameters.

7. A data generating method for generating image data of a drawing image for drawing a media image on a plurality of media to be drawn on equipped to a drawing unit to be drawn on, the data generating method comprising:
acquiring a value of a parameter for prescribing a shape of the media;
acquiring a value of a parameter for prescribing a position of the media with respect to the drawing unit to be drawn on; and
prescribing a position of the media image on the drawing image based on the values of the parameters acquired.
